(19) United States
(12) Patent Application Publication
(10) Pub. No.: US 2026/0266493 A1
(43) Pub. Date: Sep. 10, 2026

(54) AIR-CONDITIONING SYSTEM AND COMMUNICATION METHOD

(71) Applicant: Mitsubishi Electric Corporation, Tokyo (JP)

(72) Inventors: Hiroaki KOTAKE, Tokyo (JP); Hiroaki ENDO, Tokyo (JP)

(21) Appl. No.: 18/872,063

(22) PCT Filed: Nov. 21, 2022
(86) PCT No.: PCT/JP2022/042952

§ 371 Date: Dec. 5, 2024

(51) Int. Cl. F24F 11/54; F24F 11/56; F24F 110/10; F24F 110/40; H04W 12/03; H04W 12/041; H04W 12/0431; H04W 64/00

(52) U.S. Cl. CPC F24F 11/54; F24F 11/56; H04W 12/03; H04W 12/041; H04W 12/0431; H04W 64/00; F24F 2110/10; F24F 2110/40

(57) ABSTRACT

First air conditioning devices belonging to a refrigerant group execute encrypted communication with each other, which involves encryption of communication data with a common key. Second air conditioning devices belonging to a refrigerant group execute the encrypted communication with each other. When a first communication device among the first air conditioning devices communicates with a second communication device among the second air conditioning devices, a first relay device among the first air conditioning devices and a second relay device among the second air conditioning devices execute the encrypted communication with each other. The encrypted communication can achieve improved security and appropriate management of an air conditioning system.

### CROSS REFERENCE TO RELATED APPLICATION

This application is a U.S. national stage application of PCT/JP2022/042952 filed on Nov. 21, 2022, the contents of which are incorporated herein by reference.

### TECHNICAL FIELD

The present disclosure relates to an air conditioning system and a communication method.

### BACKGROUND

Some air conditioning systems have been known, which include air conditioning units each including one outdoor unit and multiple indoor units. Each air conditioning unit corresponds to a single refrigerant group. In such an air conditioning system, basically all the air conditioning devices, or all the outdoor units and all the indoor units, are connected to each other so as to be capable of communication. Patent Literature 1 discloses an air conditioning system, which includes centralized transmission lines for connection between outdoor units included in different air conditioning units, and internal/external transmission lines for connection between an outdoor unit and multiple indoor units included in each air conditioning unit.

In recent years, air conditioning systems have been a target of cyberattacks. The air conditioning systems thus require security measures against cyberattacks. A typical example of the security measures is encrypted communication involving encryption of communication data with a common key. The encrypted communication must follow the establishment of sessions between two devices that execute the encrypted communication. For example, the encrypted communication among all the air conditioning devices needs the establishment of sessions between all the pairs of air conditioning devices.

### PATENT LITERATURE

Patent Literature 1: Unexamined Japanese Patent Application Publication No. 2008-20092

As the number of sessions to be established increases, the processing period necessary for establishment of the sessions and the memory usage necessary for storage of common keys increase. Desired is an air conditioning system that can achieve secure communication while maintaining a short processing period for preparation of communication and low memory usage.

### SUMMARY

An objective of the present disclosure, which has been accomplished in view of the above problems, is to provide an air conditioning system and a communication method that can achieve secure communication while maintaining a short processing period for preparation of communication and low memory usage.

In order to achieve the above objective, an air conditioning system according to the present disclosure includes first air conditioning devices belonging to a first refrigerant group, and second air conditioning devices belonging to a second refrigerant group. The first air conditioning devices and the second air conditioning devices are connected so as to be capable of communication with each other. The first air conditioning devices execute encrypted communication with each other, involving encryption of communication data with a common key. The second air conditioning devices execute the encrypted communication with each other. When a first communication device among the first air conditioning devices communicates with a second communication device among the second air conditioning devices, a first relay device among the first air conditioning devices and a second relay device among the second air conditioning devices execute the encrypted communication with each other.

In the present disclosure, the first air conditioning devices belonging to the first refrigerant group execute encrypted communication with each other, and the second air conditioning devices belonging to the second refrigerant group execute encrypted communication with each other. When the first communication device belonging to the first refrigerant group communicates with the second communication device belonging to the second refrigerant group, the first relay device belonging to the first refrigerant group and the second relay device belonging to the second refrigerant group execute encrypted communication with each other. The present disclosure can therefore achieve secure communication while maintaining a short processing period for preparation of communication and low memory usage.

### BRIEF DESCRIPTION OF DRAWINGS

FIG. 1 illustrates a configuration of an air conditioning system according to Embodiment 1;

FIG. 2 illustrates a network configuration of the air conditioning system according to Embodiment 1;

FIG. 3 illustrates a list of sessions;

FIG. 4 illustrates a process of establishing a session;

FIG. 5 is an explanatory diagram illustrating a summary of functions of the air conditioning system according to Embodiment 1;

FIG. 6 illustrates a functional configuration of an outdoor unit according to Embodiment 1;

FIG. 7 illustrates a functional configuration of an indoor unit according to Embodiment 1;

FIG. 8 is an explanatory diagram illustrating a frame to be transmitted and received in encrypted communication;

FIG. 9 is a flowchart illustrating a frame transmitting process according to Embodiment 1;

FIG. 10 is a flowchart illustrating a frame receiving process according to Embodiment 1;

FIG. 11 illustrates functional configurations of an outdoor unit and an indoor unit according to Embodiment 2;

FIG. 12 illustrates functional configurations of an outdoor unit and an indoor unit according to Embodiment 3;

FIG. 13 illustrates a configuration of an air conditioning system according to Embodiment 4;

FIG. 14 illustrates functional configurations of an outdoor unit and an indoor unit according to Embodiment 4;

FIG. 15 illustrates a device confirmation screen displayed on a system controller according to Embodiment 5; and

FIG. 16 illustrates a network configuration of an air conditioning system according to Embodiment 6.

### DETAILED DESCRIPTION

The following describes embodiments of the present disclosure with reference to the accompanying drawings. In the drawings, the identical or corresponding components are provided with the same reference symbol.

### Embodiment 1

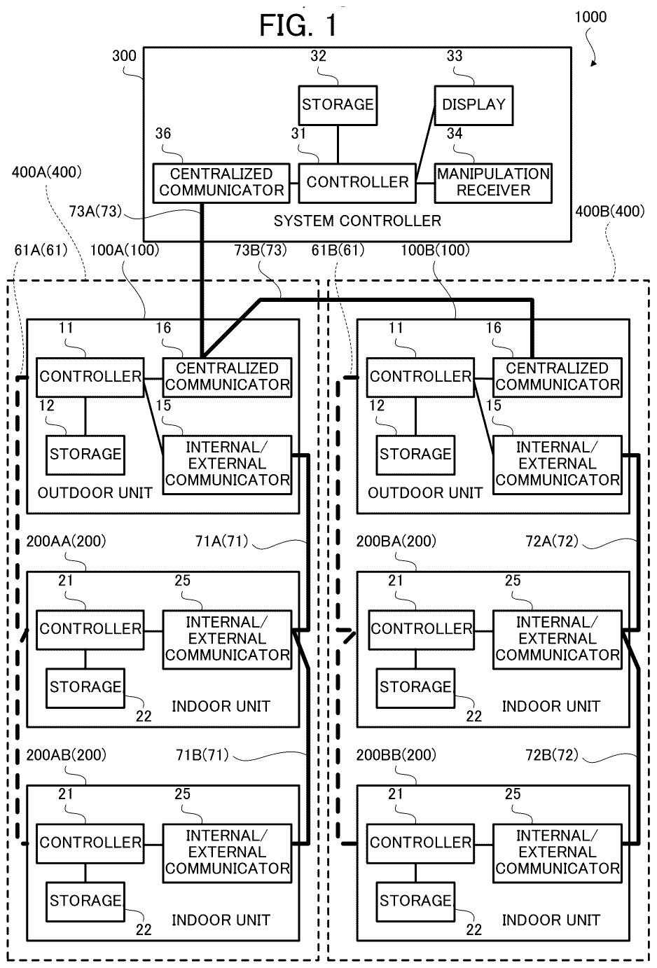

FIG. 1 illustrates a configuration of an air conditioning system 1000 according to Embodiment 1. The air conditioning system 1000 is designed to condition the air inside facilities, such as buildings, condominiums, apartments, and factories. The air conditioning system 1000 includes an outdoor unit 100A, an outdoor unit 100B, an indoor unit 200AA, an indoor unit 200AB, an indoor unit 200BA, an indoor unit 200BB, and a system controller 300.

The outdoor unit 100A and the outdoor unit 100B are hereinafter collectively referred to as “outdoor units 100”, and the indoor unit 200AA, the indoor unit 200AB, the indoor unit 200BA, and the indoor unit 200BB are hereinafter collectively referred to as “indoor units 200”, as appropriate.

The air conditioning system 1000 includes, as refrigerant groups, a refrigerant group 400A and a refrigerant group 400B. The refrigerant groups allow refrigerant, which has different states depending on conditions, such as temperature and pressure, to flow therein in the air conditioning system. The same refrigerant flows in the same refrigerant group. The refrigerant group 400A and the refrigerant group 400B are hereinafter collectively referred to as “refrigerant groups 400”, as appropriate.

The refrigerant group 400A includes the outdoor unit 100A, the indoor unit 200AA, the indoor unit 200AB, and a refrigerant pipe 61A. The refrigerant pipe 61A allows refrigerant to circulate in the outdoor unit 100A, the indoor unit 200AA, and the indoor unit 200AB. The refrigerant group 400B includes the outdoor unit 100B, the indoor unit 200BA, the indoor unit 200BB, and a refrigerant pipe 61B. The refrigerant pipe 61B allows refrigerant to circulate in the outdoor unit 100B, the indoor unit 200BA, and the indoor unit 200BB. The refrigerant pipe 61A and the refrigerant pipe 61B are hereinafter collectively referred to as “refrigerant pipes 61”, as appropriate.

The outdoor units 100 are facility devices installed in outdoor spaces, among the facility devices for conditioning the indoor air. Conditioning the indoor air means adjusting the properties, such as temperature, humidity, and cleanliness, of the indoor air. The indoor units 200 are facility devices installed in indoor spaces, among the facility devices for conditioning the indoor air. The indoor units 200 deliver air for heating, cooling, dehumidification, or air circulation, to the indoor spaces. The system controller 300 controls the outdoor units 100 and the indoor units 200, and regulates the operations of the entire air conditioning system 1000. The outdoor units 100, the indoor units 200, and the system controller 300 are connected so as to be capable of communication with each other.

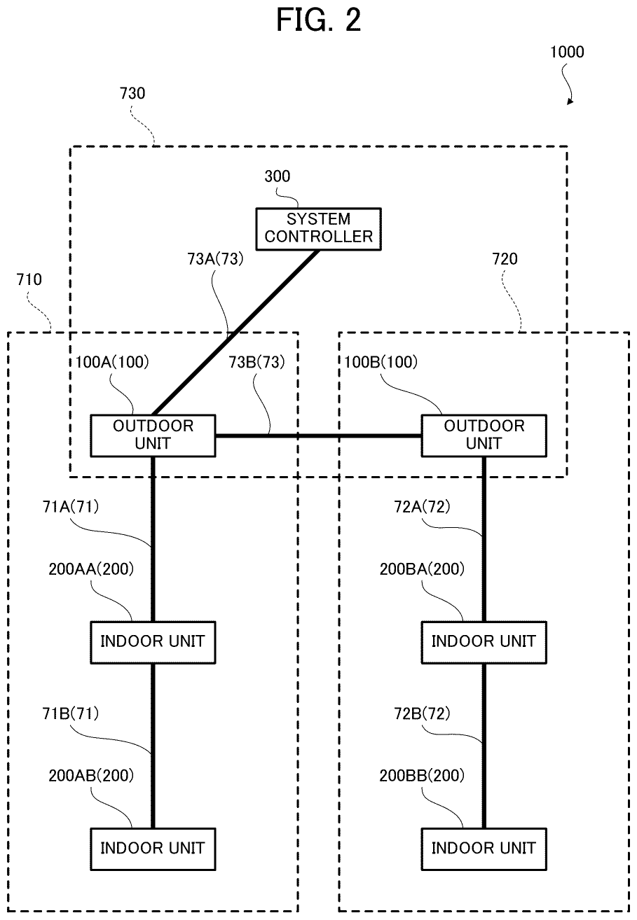

FIG. 2 illustrates a network configuration of the air conditioning system 1000. The outdoor unit 100A, the indoor unit 200AA, the indoor unit 200AB, a communication line 71A, and a communication line 71B belong to a communication network 710. The outdoor unit 100B, the indoor unit 200BA, the indoor unit 200BB, a communication line 72A, and a communication line 72B belong to a communication network 720. The outdoor unit 100A, the outdoor unit 100B, the system controller 300, a communication line 73A, and a communication line 73B belong to a communication network 730. That is, each refrigerant group 400 corresponds to a single communication network, and the outdoor units 100 and the system controller 300 correspond to another communication network, in this embodiment.

The communication line 71A connects the outdoor unit 100A to the indoor unit 200AA. The communication line 71B connects the indoor unit 200AA to the indoor unit 200AB. The communication line 72A connects the outdoor unit 100B to the indoor unit 200BA. The communication line 72B connects the indoor unit 200BA to the indoor unit 200BB. The communication line 73A connects the outdoor unit 100A to the system controller 300. The communication line 73B connects the outdoor unit 100A to the outdoor unit 100B. The communication line 71A and the communication line 71B are hereinafter collectively referred to as “communication lines 71”, the communication line 72A and the communication line 72B are hereinafter collectively referred to as “communication lines 72”, and the communication line 73A and the communication line 73B are hereinafter collectively referred to as “communication lines 73”, as appropriate. Each of the communication lines 71, 72, and 73 is an Ethernet (registered trademark) cable, for example.

Each of the communication networks 710 and 720 is configured by interconnecting the devices belonging to the same refrigerant group 400. Specifically, the communication network 710 is configured by interconnecting the devices belonging to the refrigerant group 400A. In the communication network 710, the outdoor unit 100A, the indoor unit 200AA, and the indoor unit 200AB communicate with each other, via the communication lines 71. The communication network 720 is configured by interconnecting the devices belonging to the refrigerant group 400B. In the communication network 720, the outdoor unit 100B, the indoor unit 200BA, and the indoor unit 200BB communicate with each other, via the communication lines 72.

The communication network 730 is configured by interconnecting the devices not belonging to the same refrigerant group 400. Specifically, the communication network 730 is configured by interconnecting the outdoor units 100 and the system controller 300 belonging to different refrigerant groups 400. In the communication network 730, the outdoor unit 100A, the outdoor unit 100B, and the system controller 300 communicate with each other, via the communication lines 73. Each of the communication networks 710, 720, and 730 is a local area network (LAN) capable of internet protocol (IP) communication.

The outdoor units 100, the indoor units 200, and the system controller 300 have configurations described in detail below. The description of the outdoor units 100 and the indoor units 200 mainly focuses on the configurations related to information processing and communication processing, without description of components, such as compressor, condenser, refrigerant pipe, expansion valve, or evaporator. Each of the outdoor units 100 includes a controller 11, a storage 12, an internal/external communicator 15, and a centralized communicator 16. Each of the indoor units 200 includes a controller 21, a storage 22, and an internal/external communicator 25. The system controller 300 includes a controller 31, a storage 32, a display 33, a manipulation receiver 34, and a centralized communicator 36.

The controller 11 includes a central processing unit (CPU), a read only memory (ROM), a random access memory (RAM), and a real time clock (RTC), for example. The CPU may also be called a central processing unit, central calculation unit, processor, microprocessor, microcomputer, or digital signal processor (DSP), for example. The CPU serves as a central calculation processor that executes processes and calculations related to control of the outdoor unit 100. The CPU in the controller 11 reads the programs and data stored in the ROM, and performs comprehensive control of the outdoor unit 100, using the RAM as a work area. A typical example of the RTC is an integrated circuit having a time-keeping function. On the basis of the time information read from the RTC, the CPU can specify the current date and time.

The controller 11 controls the outdoor unit 100, for example. The controller 11 executes internal/external communication with the indoor units 200, via the internal/external communicator 15. The controller 11 also executes centralized communication with another outdoor unit 100 or the system controller 300, via the centralized communicator 16. The controller 11 generates and analyzes commands in the internal/external communication and centralized communication, for example.

The storage 12 includes a non-volatile semiconductor memory, such as flash memory, erasable programmable ROM (EPROM), or electrically erasable programmable ROM (EEPROM), and serves as a so-called auxiliary storage. The storage 12 stores programs and data to be used in various processes executed by the controller 11. The storage 12 also stores data to be generated or acquired through various processes executed by the controller 11. For example, the storage 12 stores the own server certificate, route certificate, own secret key, own public key, and common keys.

The internal/external communicator 15 executes transmitting and receiving processes of the internal/external communication, under the control of the controller 11. That is, the internal/external communicator 15 communicates with any of the indoor units 200 via the communication line 71 or 72, under the control of the controller 11. The internal/external communication indicates communication between the devices belonging to the same refrigerant group 400. In other words, the outdoor unit 100A, the indoor unit 200AA, and the indoor unit 200AB belonging to the communication network 710 execute the internal/external communication. The outdoor unit 100B, the indoor unit 200BA, and the indoor unit 200BB belonging to the communication network 720 also execute the internal/external communication. The internal/external communicator 15 includes a communication interface having a communication driver integrated circuit (IC), for example.

The centralized communicator 16 executes transmitting and receiving processes of the centralized communication, under the control of the controller 11. That is, the centralized communicator 16 communicates with another outdoor unit 100 or the system controller 300 via the communication line 73, under the control of the controller 11. The centralized communication indicates communication between the devices not belonging to the same refrigerant group 400. In other words, the outdoor unit 100A, the outdoor unit 100B, and the system controller 300 belonging to the communication network 730 execute the centralized communication. The centralized communicator 16 includes a communication interface having a communication driver IC, for example.

The controller 21 includes a CPU, a ROM, a RAM, and an RTC, for example. The CPU may also be called a central processing unit, central calculation unit, processor, microprocessor, microcomputer, or DSP, for example. The CPU serves as a central calculation processor that executes processes and calculations related to control of the indoor unit 200. The CPU in the controller 21 reads the programs and data stored in the ROM, and performs comprehensive control of the indoor unit 200, using the RAM as a work area.

The controller 21 controls the indoor unit 200, for example. The controller 21 executes internal/external communication with the outdoor units 100 or other indoor units 200, via the internal/external communicator 25. The controller 21 generates and analyzes commands in the internal/external communication, for example.

The storage 22 includes a non-volatile semiconductor memory, such as flash memory, EPROM, or EEPROM, and serves as a so-called auxiliary storage. The storage 22 stores programs and data to be used in various processes executed by the controller 21. The storage 22 also stores data to be generated or acquired through various processes executed by the controller 21. For example, the storage 22 stores the own server certificate, route certificate, own secret key, own public key, and common keys.

The internal/external communicator 25 executes transmitting and receiving processes of the internal/external communication, under the control of the controller 21. That is, the internal/external communicator 25 communicates with any of the outdoor units 100 and the other indoor units 200 via the communication line 71 or 72, under the control of the controller 21. The internal/external communicator 25 includes a communication interface having a communication driver IC, for example.

The controller 31 includes a CPU, a ROM, a RAM, and an RTC, for example. The CPU may also be called a central processing unit, central calculation unit, processor, microprocessor, microcomputer, or DSP, for example. The CPU serves as a central calculation processor that executes processes and calculations related to control of the system controller 300. The CPU in the controller 31 reads the programs and data stored in the ROM, and performs comprehensive control of the system controller 300, using the RAM as a work area.

The controller 31 controls the system controller 300, for example. The controller 31 executes centralized communication with the outdoor units 100 via the centralized communicator 36. The controller 31 generates and analyzes commands in the centralized communication, for example. The controller 31 causes the display 33 to display various screens. The controller 31 acquires information received by the manipulation receiver 34 from a user.

The storage 32 includes a non-volatile semiconductor memory, such as flash memory, EPROM, or EEPROM, and serves as a so-called auxiliary storage. The storage 32 stores programs and data to be used in various processes executed by the controller 31. The storage 32 also stores data to be generated or acquired through various processes executed by the controller 31. For example, the storage 32 stores the own server certificate, route certificate, own secret key, own public key, and common keys.

The display 33 displays various images under the control of the controller 31. For example, the display 33 displays a screen for receiving various manipulations from the user. The display 33 includes a touch screen or a liquid crystal display, for example. The manipulation receiver 34 receives various manipulations from the user, and provides the controller 31 with information indicating the contents of the received manipulations. The manipulation receiver 34 includes a touch screen, buttons, or levers, for example.

The centralized communicator 36 executes transmitting and receiving processes of the centralized communication, under the control of the controller 31. That is, the centralized communicator 36 communicates with either of the outdoor units 100 via the communication line 73, under the control of the controller 31. The centralized communicator 36 includes a communication interface having a communication driver IC, for example.

The following describes communication between the devices included in the air conditioning system 1000. The devices included in the air conditioning system 1000 execute internal/external communication or centralized communication with each other. Specifically, the devices belonging to the communication network 710 execute internal/external communication with each other. The devices belonging to the communication network 720 execute internal/external communication with each other. The devices belonging to the communication network 730 execute centralized communication with each other.

In contrast, the communication between the devices not belonging to the same communication network is relayed by the outdoor units 100. For example, the indoor unit 200AA belonging to the communication network 710 communicates, via the outdoor units 100A and 100B, with the indoor unit 200BB belonging to the communication network 720. In this case, the indoor unit 200AA executes internal/external communication with the outdoor unit 100A, the outdoor unit 100A executes centralized communication with the outdoor unit 100B, and the outdoor unit 100B executes internal/external communication with the indoor unit 200BB.

The internal/external communication and the centralized communication in this embodiment are both IP communication, which involves assigning IP addresses unique to the devices included in the air conditioning system 1000. The internal/external communication and the centralized communication in this embodiment both involve server verification and encrypted communication pursuant to the transport layer security (TLS).

Each of the devices included in the air conditioning system 1000 has a server certificate unique to the device, a secret key unique to the device, a public key unique to the device, and a route certificate common in the air conditioning system 1000. The route certificate may be prepared by the manufacturer of the device, provided from the user at the building of the system, or generated from information acquired from the user at the building of the system. The device included in the air conditioning system 1000 may generate a common key necessary in encrypted communication for oneself, or receive the common key from another device.

In general, the server verification and encrypted communication pursuant to the TLS protocol involve establishing sessions of end-to-end communication at the start. In this embodiment, the devices belonging to the same communication network establish sessions therebetween, while the devices not belonging to the same communication network do not establish sessions therebetween. The communication between the devices not belonging to the same communication network is relayed by the outdoor units 100 in this embodiment. This configuration can prevent an increase in the activation period until the start of communication and an increase in the memory usage. The configuration can thus achieve secure communication while maintaining a short processing period for preparation of communication and low memory usage.

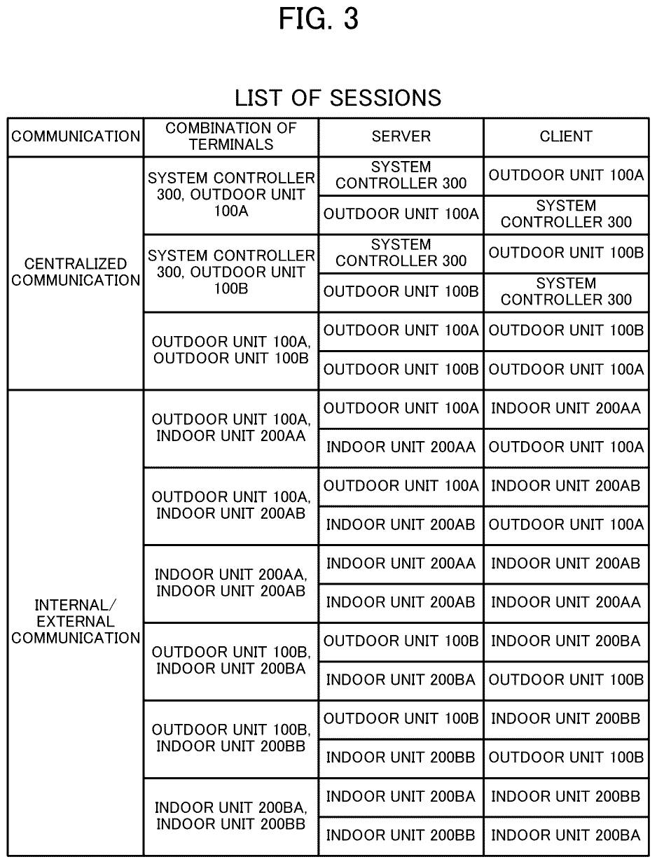

FIG. 3 illustrates a list of sessions to be established in this embodiment. As illustrated in FIG. 3, only the devices belonging to the same communication network establish sessions therebetween in this embodiment. A pair of devices establish two sessions therebetween including a session between one device serving as a server and the other device serving as a client, and a session between the other device serving as a server and the one device serving as a client.

The following description assumes that, for example, the system controller 300 communicates with the outdoor unit 100A. In this case, the system controller 300 serving as a server and the outdoor unit 100A serving as a client establish a session therebetween, and ensure the security in the communication direction from the outdoor unit 100A to the system controller 300. Then, the outdoor unit 100A serving as a server and the system controller 300 serving as a client establish another session therebetween, and ensure the security in the communication direction from the system controller 300 to the outdoor unit 100A.

In a general example of establishment of sessions of end-to-end communication, the number of devices to establish interactive sessions is ₇C₂=21, and the devices are thus required to establish 21×2=42 sessions therebetween. In contrast, in this embodiment, the number of devices to establish interactive sessions is nine, and the devices are thus only required to establish 9×2=18 sessions therebetween.

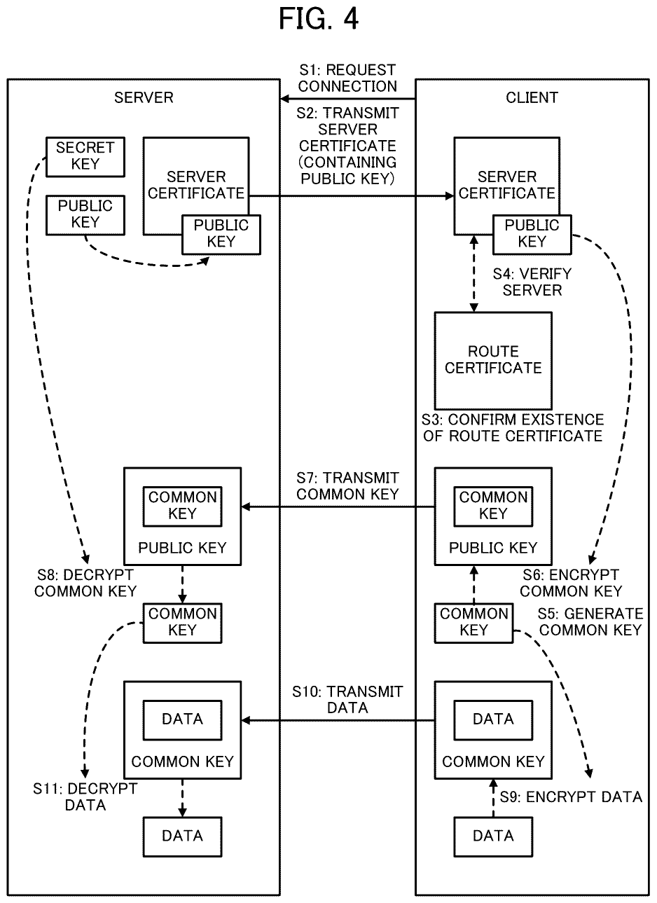

The following describes a process of establishing a session in the verification of a server by a client, with reference to FIG. 4. This process is designed to establish a TLS session in the public key cryptosystem.

In Step S1, the client transmits a request for connection to the server. In Step S2, the server transmits a server certificate containing a public key of the server, to the client. In Step S3, the client confirms that the client has a route certificate of the certification authority that signed the server certificate. In Step S4, the client decrypts the digital signature contained in the server certificate, with the public key contained in the route certificate, and checks for the properness of the server.

In Step S5, the client generates a common key for use in encrypted communication. In Step S6, the client encrypts the generated common key, with the public key of the server. In Step S7, the client transmits the common key encrypted with the public key of the server, to the server. In Step S8, the server decrypts the common key encrypted with the public key of the server, with the secret key of the server, and thus obtains the common key.

In Step S9, the client encrypts data to be transmitted to the server, with the common key. In Step S10, the client transmits the data encrypted with the common key, to the server. In Step S11, the server decrypts the data encrypted with the common key, with the common key, and thus obtains the data.

Steps S1 to S11 ensure the security in the communication direction from the client to the server. Steps S1 to S11 are executed again after switching the client and the server, and thus ensure the security in both communication directions. For example, when the system controller 300 serving as a server and the outdoor unit 100A serving as a client execute Steps S1 to S11, the steps ensure the security in the communication direction from the outdoor unit 100A to the system controller 300. When the system controller 300 serving as a client and the outdoor unit 100A serving as a server execute Steps S1 to S11, the steps ensure the security in the communication direction from the system controller 300 to the outdoor unit 100A.

The common key, if used for a long period, is more likely to be leaked and cause some risks. This problem requires the establishment of sessions at regular intervals and update of the common key at regular intervals.

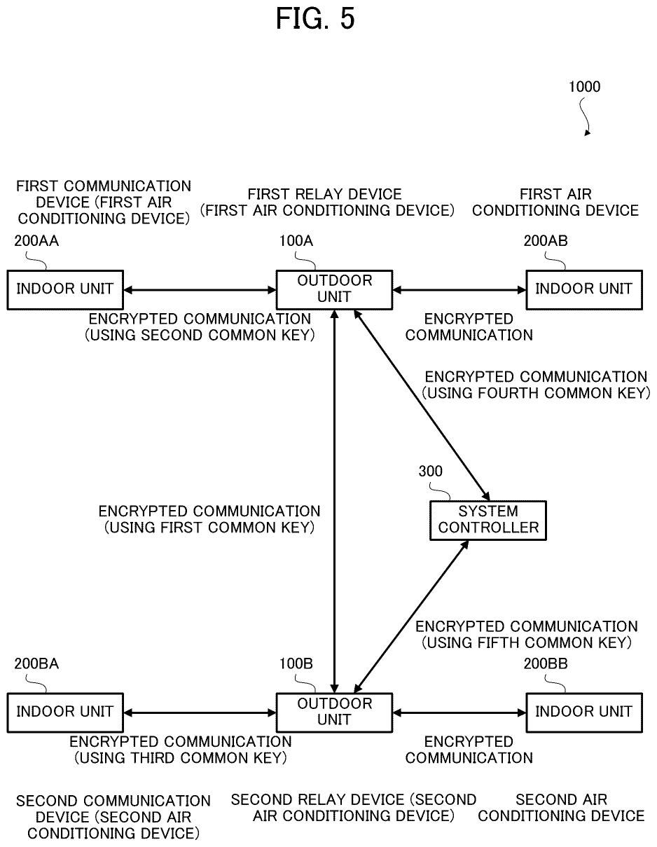

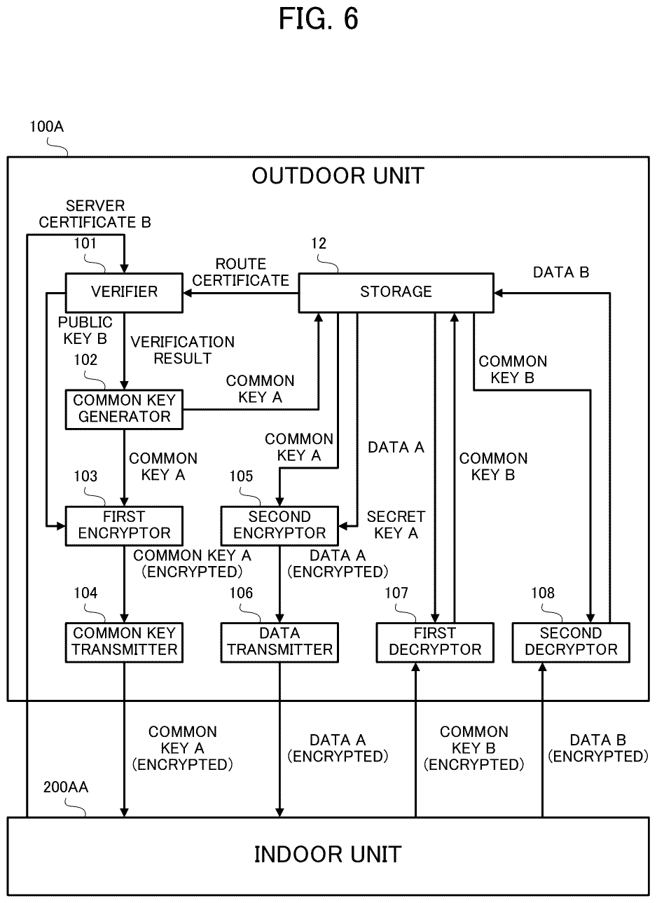

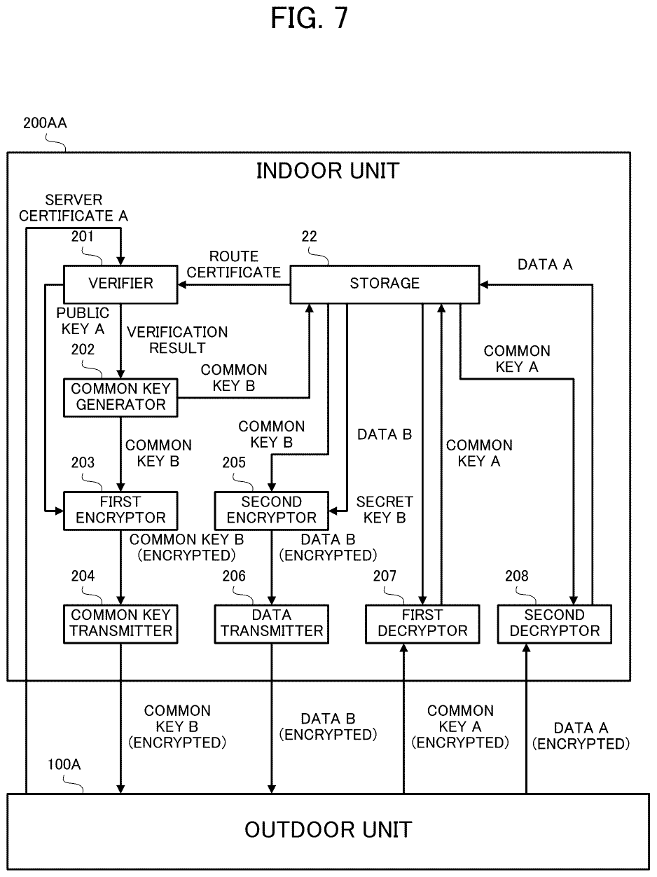

The following describes functions of the air conditioning system 1000, with reference to FIGS. 5, 6, and 7. FIG. 5 is an explanatory diagram illustrating a summary of functions of the air conditioning system 1000. FIG. 6 illustrates a functional configuration of the outdoor unit 100A. FIG. 7 illustrates a functional configuration of the indoor unit 200AA.

The air conditioning system 1000 includes first air conditioning devices belonging to a first refrigerant group, and second air conditioning devices belonging to a second refrigerant group. The first air conditioning devices and the second air conditioning devices are connected so as to be capable of communication with each other. The refrigerant group 400A is an example of the first refrigerant group, and the refrigerant group 400B is an example of the second refrigerant group. The outdoor unit 100A, the indoor unit 200AA, and the indoor unit 200AB are examples of the first air conditioning devices, and the outdoor unit 100B, the indoor unit 200BA, and the indoor unit 200BB are examples of the second air conditioning devices.

The first air conditioning devices execute encrypted communication with each other, which involves encrypting communication data with a common key. That is, the outdoor unit 100A, the indoor unit 200AA, and the indoor unit 200AB execute encrypted communication with each other. The second air conditioning devices execute encrypted communication with each other. In other words, the outdoor unit 100B, the indoor unit 200BA, and the indoor unit 200BB execute encrypted communication with each other.

The first relay device and the second relay device execute encrypted communication with each other, when the first communication device communicates with the second communication device. The first relay device is any of the first air conditioning devices. The second relay device is any of the second air conditioning devices. The first communication device is any of the first air conditioning devices. The second communication device is any of the second air conditioning devices. The first relay device may also be the first communication device, and the second relay device may also be the second communication device.

The outdoor unit 100A is an example of the first relay device, and the outdoor unit 100B is an example of the second relay device. The outdoor unit 100A, the indoor unit 200AA, and the indoor unit 200AB are examples of the first communication device, and the outdoor unit 100B, the indoor unit 200BA, and the indoor unit 200BB are examples of the second communication device. FIG. 5 illustrates an example in which the indoor unit 200AA corresponds to the first communication device while the indoor unit 200BA corresponds to the second communication device.

The first relay device, when the first relay device is not the first communication device, relays communication between the first communication device and the second communication device. Specifically, the first relay device executes, with the second relay device, encrypted communication using a first common key shared by the first and second relay devices. The first relay device executes, with the first communication device, encrypted communication using a second common key shared by the first relay device and the first communication device.

The second relay device, when the second relay device is not the second communication device, relays communication between the first communication device and the second communication device. Specifically, the second relay device executes encrypted communication using the first common key, with the first relay device. The second relay device executes, with the second communication device, encrypted communication using a third common key shared by the second relay device and the second communication device.

The first relay device, when the first relay device is the first communication device, executes encrypted communication using the first common key with the second relay device, for the purpose of communication with the second communication device. The second relay device, when the second relay device is the second communication device, executes encrypted communication using the first common key with the first relay device, for the purpose of communication with the first communication device.

The first relay device and the system controller 300 execute encrypted communication with each other, when the first communication device communicates with the system controller 300. The second relay device and the system controller 300 execute encrypted communication with each other, when the second communication device communicates with the system controller 300.

The first relay device, when the first relay device is not the first communication device, relays communication between the first communication device and the system controller 300. Specifically, the first relay device executes encrypted communication using the second common key with the first communication device, and then executes encrypted communication using a fourth common key with the system controller 300. The fourth common key is shared by the first relay device and the system controller 300.

The second relay device, when the second relay device is not the second communication device, relays communication between the second communication device and the system controller 300. Specifically, the second relay device executes encrypted communication using the third common key with the second communication device, and then executes encrypted communication using a fifth common key with the system controller 300. The fifth common key is shared by the second relay device and the system controller 300.

In this embodiment, the common key is prepared for each communication direction. For example, the first and second relay devices share, as the first common key, a common key for use in data transmission from the first relay device to the second relay device, and a common key for use in data transmission from the second relay device to the first relay device. The second, third, fourth, and fifth common keys are also prepared for each communication direction.

The first air conditioning devices belong to a first communication network. The second air conditioning devices belong to a second communication network. The first and second relay devices belong to a third communication network. The communication network 710 is an example of the first communication network. The communication network 720 is an example of the second communication network. The communication network 730 is an example of the third communication network.

A third communication device includes verification means, common key generating means, and common key transmitting means. The third communication device is any device among the first and second air conditioning devices. The outdoor unit 100A, the outdoor unit 100B, the indoor unit 200AA, the indoor unit 200AB, the indoor unit 200BA, and the indoor unit 200BB are examples of the third communication device.

The verification means verifies a fourth communication device. The fourth communication device is a device, among the first and second air conditioning devices, which communicates with the third communication device. The outdoor unit 100A, the outdoor unit 100B, the indoor unit 200AA, the indoor unit 200AB, the indoor unit 200BA, and the indoor unit 200BB are examples of the fourth communication device. The common key generating means generates a common key for use in encrypted communication. The common key transmitting means, after the verification of the fourth communication device by the verification means, transmits the common key generated by the common key generating means, to the fourth communication device.

The following describes functions of the outdoor unit 100A and functions of the indoor unit 200AA with reference to FIGS. 6 and 7, focusing on an example in which the outdoor unit 100A communicates with the indoor unit 200AA. When the outdoor unit 100A corresponds to the third communication device, the indoor unit 200AA corresponds to the fourth communication device. When the outdoor unit 100A corresponds to the fourth communication device, the indoor unit 200AA corresponds to the third communication device. That is, the communication partner of the outdoor unit 100A is the indoor unit 200AA, and the communication partner of the indoor unit 200AA is the outdoor unit 100A.

The outdoor unit 100A has functional components including a verifier 101, a common key generator 102, a first encryptor 103, a common key transmitter 104, a second encryptor 105, a data transmitter 106, a first decryptor 107, and a second decryptor 108. The indoor unit 200AA has functional components including a verifier 201, a common key generator 202, a first encryptor 203, a common key transmitter 204, a second encryptor 205, a data transmitter 206, a first decryptor 207, and a second decryptor 208. The indoor unit 200AA has basically the same functions as the outdoor unit 100A except for that the indoor unit 200AA lacks the relay function.

These functions are performed by software, firmware, or a combination of software and firmware. The software and firmware are described in the form of programs, and stored in the ROM or the storage 12 or 22. These programs stored in the ROM or the storage 12 or 22 are executed by the CPU and thus achieve the functions.

The verifier 101 verifies the communication-partner device. For example, the verifier 101 verifies the indoor unit 200AA, by acquiring a server certificate from the indoor unit 200AA, and decrypting the digital signature contained in the server certificate, with the public key contained in the route certificate stored in the storage 12. The “server certificate B” illustrated in FIG. 6 indicates the server certificate of the indoor unit 200AA. The verifier 101 is an example of the verification means.

The common key generator 102 generates a common key for use in encrypted communication. The “common key A” illustrated in FIG. 6 indicates the common key generated by the outdoor unit 100A, which is used in data transmission from the outdoor unit 100A to the indoor unit 200AA. The common key generated by the common key generator 102 is stored into the storage 12. The common key generator 102 is an example of the common key generating means. The first encryptor 103 encrypts the common key generated by the common key generator 102, with the public key of the communication-partner device. The public key of the communication-partner device is contained in the server certificate acquired from the communication-partner device. The “public key B” illustrated in FIG. 6 indicates the public key of the indoor unit 200AA. The first encryptor 103 is an example of the encryption means.

After the verification of the communication-partner device by the verifier 101, the common key transmitter 104 transmits the common key encrypted by the first encryptor 103, to the communication-partner device. The common key transmitter 104 is an example of the common key transmitting means. The second encryptor 105 encrypts data to be transmitted to the communication-partner device, with the common key generated by the common key generator 102. The “data A” illustrated in FIG. 6 indicates the data to be transmitted from the outdoor unit 100A to the indoor unit 200AA. The data transmitter 106 transmits the data encrypted by the second encryptor 105 to the communication-partner device.

The first decryptor 107 decrypts the encrypted common key received from the communication-partner device, with the secret key of the outdoor unit 100A. This common key was encrypted by the communication-partner device, with the public key of the outdoor unit 100A. The public key of the outdoor unit 100A is contained in the server certificate transmitted from the outdoor unit 100A to the communication-partner device. The “common key B” illustrated in FIG. 6 indicates the common key generated by the indoor unit 200AA, which is used in data transmission from the indoor unit 200AA to the outdoor unit 100A. The “secret key A” illustrated in FIG. 6 indicates the secret key of the outdoor unit 100A. The common key decrypted by the first decryptor 107 is stored into the storage 12.

The second decryptor 108 decrypts the encrypted data received from the communication-partner device, with the common key stored in the storage 12. This data was encrypted by the communication-partner device, with the common key generated by the communication-partner device. The “data B” illustrated in FIG. 6 indicates the data transmitted from the indoor unit 200AA to the outdoor unit 100A. The data decrypted by the second decryptor 108 is stored into the storage 12.

The outdoor unit 100A may transfer data received from another communication device, to the indoor unit 200AA serving as the communication-partner device. In this case, the second decryptor 108 decrypts the data received from another communication device, with a common key C. The second encryptor 105 encrypts this decrypted data with the common key A. The data transmitter 106 transmits this encrypted data to the indoor unit 200AA. The other communication device corresponds to the outdoor unit 100B or the system controller 300. The common key C was generated by the other communication device, and used in data transmission from the other communication device to the outdoor unit 100A.

The verifier 201 verifies the communication-partner device. For example, the verifier 201 verifies the outdoor unit 100A, by acquiring a server certificate from the outdoor unit 100A, and decrypting the digital signature contained in the server certificate, with the public key contained in the route certificate stored in the storage 22. The “server certificate A” illustrated in FIG. 7 indicates the server certificate of the outdoor unit 100A. The verifier 201 is an example of the verification means.

The common key generator 202 generates a common key for use in encrypted communication. The common key generated by the common key generator 202 is stored into the storage 22. The common key generator 202 is an example of the common key generating means. The first encryptor 203 encrypts the common key generated by the common key generator 202, with the public key of the communication-partner device. The “public key A” illustrated in FIG. 7 indicates the public key of the outdoor unit 100A. The first encryptor 203 is an example of the encryption means.

After the verification of the communication-partner device by the verifier 201, the common key transmitter 204 transmits the common key encrypted by the first encryptor 203, to the communication-partner device. The common key transmitter 204 is an example of the common key transmitting means. The second encryptor 205 encrypts data to be transmitted to the communication-partner device, with the common key generated by the common key generator 202. The data transmitter 206 transmits the data encrypted by the second encryptor 205 to the communication-partner device.

The first decryptor 207 decrypts the encrypted common key received from the communication-partner device, with the secret key of the indoor unit 200AA. The “secret key B” illustrated in FIG. 7 indicates the secret key of the indoor unit 200AA. The common key decrypted by the first decryptor 207 is stored into the storage 22. The second decryptor 208 decrypts the encrypted data received from the communication-partner device, with the common key stored in the storage 22. The data decrypted by the second decryptor 208 is stored into the storage 22.

In this embodiment, the outdoor unit 100A, the outdoor unit 100B, the indoor unit 200AA, the indoor unit 200AB, the indoor unit 200BA, the indoor unit 200BB, and the system controller 300 are capable of encrypted communication. The outdoor unit 100A and the outdoor unit 100B are also capable of relaying communication between other devices by means of encrypted communication. That is, the outdoor unit 100B has basically the same functions as the outdoor unit 100A, in terms of encrypted communication. The indoor unit 200AB, the indoor unit 200BA, the indoor unit 200BB, and the system controller 300 have basically the same functions as the indoor unit 200AA, in terms of encrypted communication.

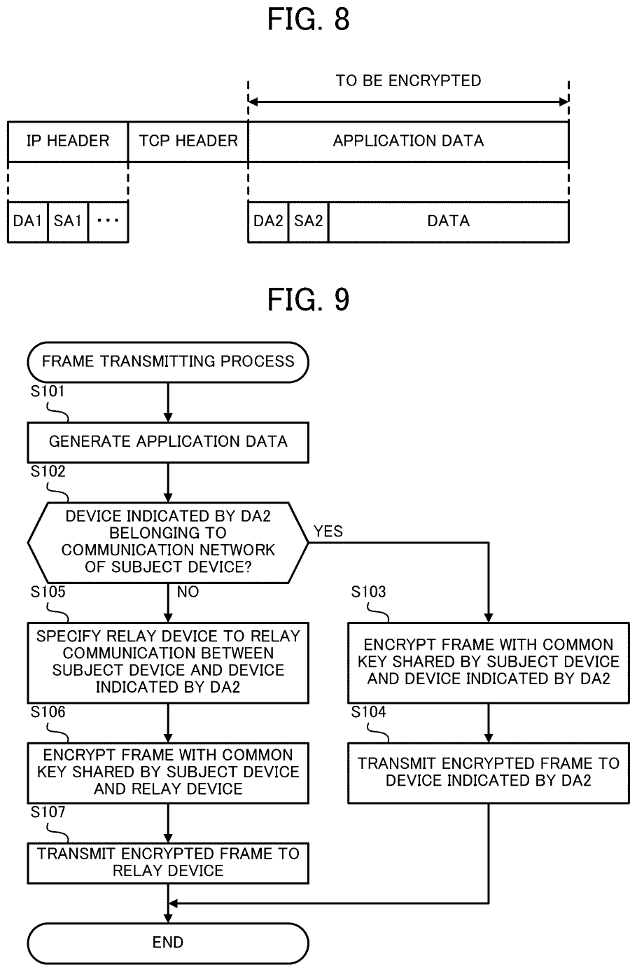

After establishing sessions between the devices, the devices communicate with each other by encrypting a frame with the common key. The frame to be transmitted and received between the devices are described below with reference to FIG. 8. As illustrated in FIG. 8, the frame contains an IP header, a TCP header, and application data.

The IP header contains information used in IP communication. Examples of the information used in IP communication includes an IP version, a source address, and a destination address. “DA1” illustrated in FIG. 8 indicates the destination address, and “SA1” indicates the source address. The TCP header contains information used in TCP communication.

The application data is intended for use in an application concerning the air conditioning control. The application data is subject to encryption in this embodiment. The application data is an example of the communication data. The application data contains a source address, a destination address, and data, for example. “DA2” illustrated in FIG. 8 indicates the destination address, “SA2” indicates the source address, and “data” indicates data concerning the air conditioning control. The source address and the destination address contained in the application data are not varied during transmission and reception of the frame.

In contrast, the source address and the destination address contained in the IP header are rewritten as appropriate, during transmission and reception of the frame. The following description assumes that, for example, the frame is transmitted from a communication device A to a communication device B.

In the case of the communication devices A and B belonging to the same communication network, the source address and the destination address contained in the IP header are not varied. For example, the communication device A transmits, to the communication device B, the frame provided with the address of the communication device B in DA1 and DA2 and provided with the address of the communication device A in SA1 and SA2. In this case, the frame received by the communication device B is also provided with the address of the communication device B in DA1 and DA2 and provided with the address of the communication device A in SA1 and SA2.

In contrast, in the case of the communication device A belonging to a communication network A alone and the communication device B belonging to both communication networks B and C, the source address and the destination address contained in the IP header are varied. For example, the communication device A transmits the frame provided with the address of a relay device A in DA1, provided with the address of the communication device B in DA2, and provided with the address of the communication device A in SA1 and SA2, to the relay device A. The relay device A relays communication between the communication devices A and B, and belongs to both the communication networks A and C. The relay device A transmits, to the communication device B, the frame provided with the address of the communication device B in DA1, provided with the address of the relay device A in SA1, provided with the address of the communication device B in DA2, and provided with the address of the communication device A in SA2.

In the case of the communication device A belonging to the communication network A alone and the communication device B belonging to the communication network B alone, the source address and the destination address contained in the IP header are varied. For example, the communication device A transmits the frame provided with the address of the relay device A in DA1, provided with the address of the communication device B in DA2, and provided with the address of the communication device A in SA1 and SA2, to the relay device A. The relay device A transmits, to the relay device B, the frame provided with the address of a relay device B in DA1, provided with the address of the relay device A in SA1, provided with the address of the communication device B in DA2, and provided with the address of the communication device A in SA2. The relay device B relays communication between the communication devices A and B, and belongs to both the communication networks B and C. The relay device B transmits, to the communication device B, the frame provided with the address of the communication device B in DA1, provided with the address of the relay device B in SA1, provided with the address of the communication device B in DA2, and provided with the address of the communication device A in SA2.

The outdoor units 100, the indoor units 200, and the system controller 300 execute a frame transmitting process, which is described below with reference to FIG. 9. The frame transmitting process is initiated in response to the occurrence of a trigger indicating necessity of transmission of a frame to another device, after establishing sessions between the devices, for example. The following description assumes that, for example, the frame transmitting process is executed by the outdoor unit 100A serving as the subject device.

The controller 11 of the outdoor unit 100A first generates application data (Step S101). For example, the controller 11 generates application data containing control commands concerning the air conditioning control as the data, and provided with the address of the destination of the control commands in DA2 and provided with the address of the outdoor unit 100A in SA2. After completion of Step S101, the controller 11 determines whether the device indicated by DA2 contained in the application data belongs to the same communication network as the subject device (Step S102). In the case of the subject device belonging to multiple communication networks, the controller 11 determines whether the device indicated by DA2 belongs to any of the communication networks to which the subject device belongs.

When determining that the device indicated by DA2 belongs to the same communication network as the subject device (Step S102: YES), the controller 11 encrypts the frame with the common key shared by the subject device and the device indicated by DA2 (Step S103). The encryption of the frame means the encryption of the application data contained in the frame. After completion of Step S103, the controller 11 transmits the encrypted frame to the device indicated by DA2 (Step S104). That is, the controller 11 assigns the address indicated by DA2 to DA1, assigns the address of the subject device to SA1, and then transmits the frame.

In contrast, when determining that the device indicated by DA2 does not belong to the same communication network as the subject device (Step S102: NO), the controller 11 specifies the relay device to relay communication between the subject device and the device indicated by DA2 (Step S105). This relay device belongs to both the same communication network as the subject device and another communication network. After completion of Step S105, the controller 11 encrypts the frame with the common key shared by the subject device and the relay device (Step S106).

After completion of Step S106, the controller 11 transmits the encrypted frame to the relay device (Step S107). That is, the controller 11 assigns the address of the relay device to DA1, assigns the address of the subject device to SA1, and then transmits the frame. After completion of Step S104 or S107, the controller 11 terminates the frame transmitting process.

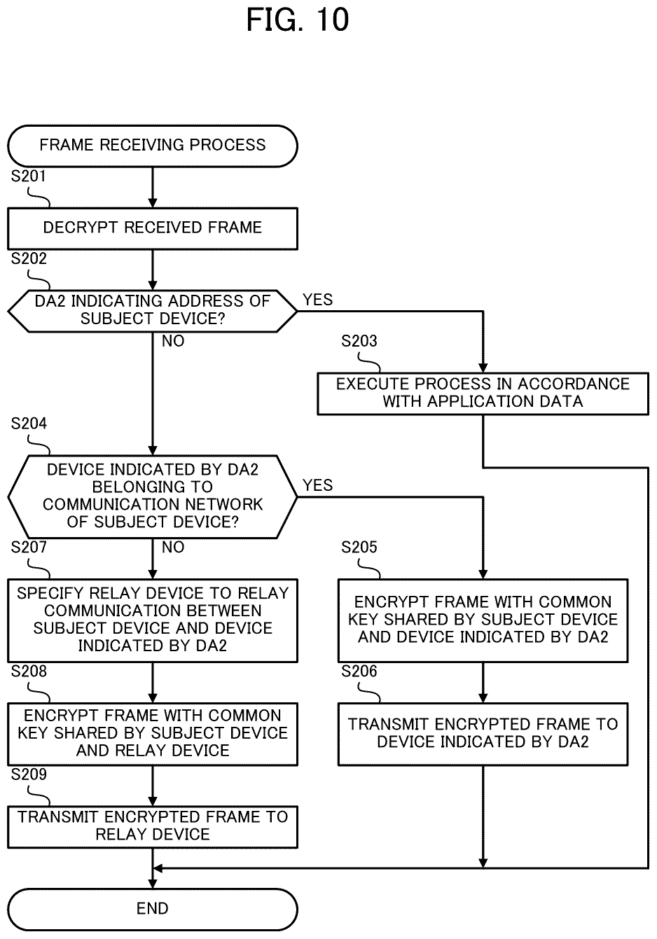

The outdoor units 100, the indoor units 200, and the system controller 300 execute a frame receiving process, which is described below with reference to FIG. 10. The frame receiving process is initiated in response to reception of a frame from another device, after establishing sessions between the devices, for example. The following description assumes that, for example, the frame receiving process is executed by the outdoor unit 100A serving as the subject device.

The controller 11 first decrypts the received frame (Step S201). The controller 11 decrypts the frame, with the common key shared by the device that transmitted the frame and the subject device. After completion of Step S201, the controller 11 determines whether DA2 contained in the decrypted frame indicates the address of the subject device (Step S202). When determining that DA2 indicates the address of the subject device (Step S202: YES), the controller 11 executes the process in accordance with the application data contained in the frame (Step S203). For example, the controller 11 executes the process in accordance with the control commands when the application data contains the control commands.

In contrast, when determining that DA2 does not indicate the address of the subject device (Step S202: NO), the controller 11 determines whether the device indicated by DA2 contained in the decrypted frame belongs to the same communication network as the subject device (Step S204).

When determining that the device indicated by DA2 belongs to the same communication network as the subject device (Step S204: YES), the controller 11 encrypts the frame with the common key shared by the subject device and the device indicated by DA2 (Step S205). After completion of Step S205, the controller 11 transmits the encrypted frame to the device indicated by DA2 (Step S206). That is, the controller 11 assigns the address of the device indicated by DA2 to DA1, assigns the address of the subject device to SA1, and then transmits the frame.

In contrast, when determining that the device indicated by DA2 does not belong to the same communication network as the subject device (Step S204: NO), the controller 11 specifies the relay device to relay communication between the subject device and the device indicated by DA2 (Step S207). This relay device belongs to both the same communication network as the subject device and the communication network to which the device indicated by DA2 belongs. After completion of Step S207, the controller 11 encrypts the frame with the common key shared by the subject device and the relay device (Step S208).

After completion of Step S208, the controller 11 transmits the encrypted frame to the relay device (Step S209). That is, the controller 11 assigns the address of the relay device to DA1, assigns the address of the subject device to SA1, and then transmits the frame. After completion of Step S203, S206, or S209, the controller 11 terminates the frame receiving process.

The outdoor unit 100B, the indoor unit 200AA, the indoor unit 200AB, the indoor unit 200BA, the indoor unit 200BB, and the system controller 300 execute the frame transmitting process and the frame receiving process, like the outdoor unit 100A. The indoor unit 200AA, the indoor unit 200AB, the indoor unit 200BA, the indoor unit 200BB, and the system controller 300, however, do not relay communication by means of encrypted communication. Specifically, the frame receiving process executed by these devices not relaying communication always results in YES in the determination in Step S202 and thus skips Steps S204 to S209.

The following describes specific processes executed by the individual devices in the case of transmission of a frame from the indoor unit 200AA to the indoor unit 200BA.

In Step S101, the indoor unit 200AA first generates application data to be transmitted to the indoor unit 200BA. The application data is provided with the address of the indoor unit 200BA in DA2 and provided with the address of the indoor unit 200AA in SA2. In Step S102, the indoor unit 200AA determines that the indoor unit 200BA indicated by DA2 does not belong to the same communication network 710 as the indoor unit 200AA. In Step S105, the indoor unit 200AA specifies the outdoor unit 100A to relay the communication between the indoor unit 200AA and the indoor unit 200BA.

In Step S106, the indoor unit 200AA encrypts the frame with the common key shared by the indoor unit 200AA and the outdoor unit 100A. In Step S107, the indoor unit 200AA transmits the encrypted frame to the outdoor unit 100A. This frame is provided with the address of the outdoor unit 100A in DA1 and provided with the address of the indoor unit 200AA in SA1.

In Step S201, the outdoor unit 100A decrypts the frame received from the indoor unit 200AA, with the common key shared by the indoor unit 200AA and the outdoor unit 100A. In Step S202, the outdoor unit 100A determines that DA2 contained in the decrypted frame does not indicate the address of the outdoor unit 100A. In Step S204, the outdoor unit 100A determines that the indoor unit 200BA indicated by DA2 does not belong to either of the communication networks 710 and 730 to which the outdoor unit 100A belongs.

In Step S207, the outdoor unit 100A specifies the outdoor unit 100B to relay communication between the outdoor unit 100A and the indoor unit 200BA. In Step S208, the outdoor unit 100A encrypts the frame with the common key shared by the outdoor units 100A and 100B. In Step S209, the outdoor unit 100A transmits the encrypted frame to the outdoor unit 100B. This frame is provided with the address of the outdoor unit 100B in DA1 and provided with the address of the outdoor unit 100A in SA1.

In Step S201, the outdoor unit 100B decrypts the frame received from the outdoor unit 100A, with the common key shared by the outdoor units 100A and 100B. In Step S202, the outdoor unit 100B determines that DA2 contained in the decrypted frame does not indicate the address of the outdoor unit 100B. In Step S204, the outdoor unit 100B determines that the indoor unit 200BA indicated by DA2 belongs to the same communication network 720 as the outdoor unit 100B.

In Step S205, the outdoor unit 100B encrypts the frame with the common key shared by the outdoor unit 100B and the indoor unit 200BA. In Step S206, the outdoor unit 100B transmits the encrypted frame to the indoor unit 200BA. This frame is provided with the address of the indoor unit 200BA in DA1 and provided with the address of the outdoor unit 100B in SA1.

In Step S201, the indoor unit 200BA decrypts the frame received from the outdoor unit 100B, with the common key shared by the outdoor unit 100B and the indoor unit 200BA. In Step S202, the indoor unit 200BA determines that DA2 contained in the decrypted frame indicates the address of the indoor unit 200BA. In Step S203, the indoor unit 200BA executes the process in accordance with the application data contained in the decrypted frame.

In this embodiment, when the first communication device belonging to the first refrigerant group communicates with the second communication device belonging to the second refrigerant group, the first relay device belonging to the first refrigerant group and the second relay device belonging to the second refrigerant group execute encrypted communication with each other. That is, the encrypted communication is executed between the first air conditioning devices, between the second air conditioning devices, and between the first and second relay devices, in this embodiment. This embodiment has an advantage of a small number of sessions established in the air conditioning system 1000. The embodiment can therefore achieve secure communication while maintaining a short processing period for preparation of communication and low memory usage.

In this embodiment, the first relay device, when the first relay device is not the first communication device, relays communication between the first communication device and the second communication device. The second relay device, when the second relay device is not the second communication device, relays communication between the first communication device and the second communication device. The first relay device, when the first relay device is not the first communication device, also relays communication between the first communication device and the system controller 300. The second relay device, when the second relay device is not the second communication device, also relays communication between the second communication device and the system controller 300. This embodiment can therefore allow the first and second relay devices to appropriately relay communication by means of encrypted communication.

In this embodiment, the first air conditioning devices belong to the first communication network, the second air conditioning devices belong to the second communication network, and the first and second relay devices belong to the third communication network. The embodiment can thus readily achieve separation of the communication between the devices belonging to the same refrigerant group from the communication between the devices belonging to different refrigerant groups. The embodiment can therefore readily specify the devices belonging to the same refrigerant group.

In this embodiment, the verification of the communication-partner device is followed by sharing of the common key. The embodiment can therefore prevent any inappropriate device from being connected to the air conditioning system 1000.

### Embodiment 2

Embodiment 1 demonstrates an example in which the common key is prepared for each communication direction. This embodiment demonstrates an example in which the same common key is applied to both communication directions. The configurations and functions identical to those in Embodiment 1 are briefly described below without redundant description, as appropriate.

An air conditioning system according to this embodiment has basically the same configuration as the air conditioning system 1000 according to Embodiment 1. Specifically, the air conditioning system according to this embodiment includes two outdoor units, four indoor units, and a system controller, and one outdoor unit and two indoor units belong to each of two refrigerant groups. In this embodiment, one of the refrigerant groups includes an outdoor unit 120A and an indoor unit 220AA.

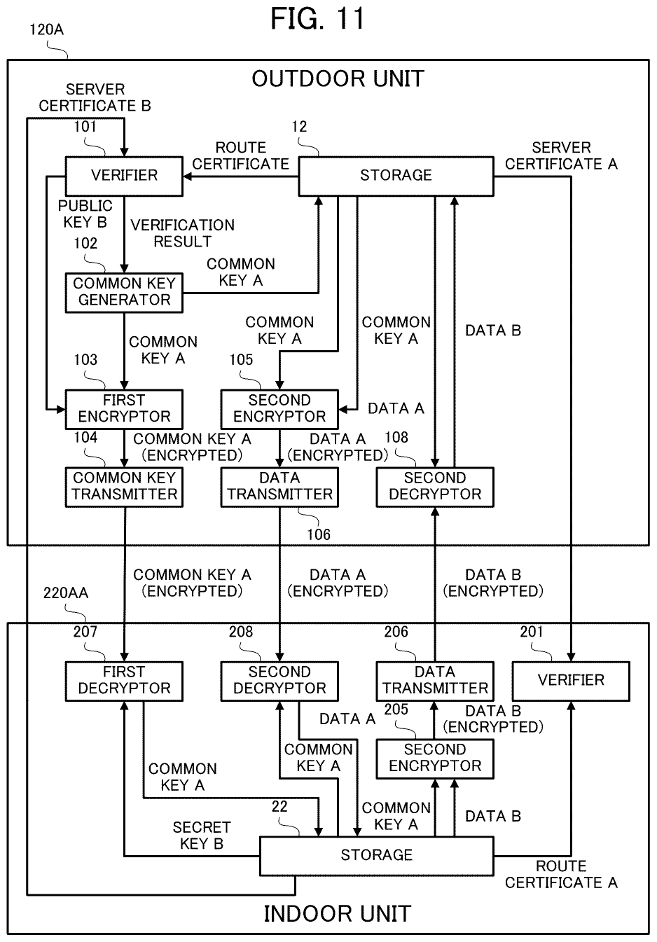

The following describes functions of the outdoor unit 120A and functions of the indoor unit 220AA with reference to FIG. 11, focusing on an example in which the outdoor unit 120A communicates with the indoor unit 220AA. In this embodiment, the outdoor unit 120A corresponds to the third communication device, and the indoor unit 220AA corresponds to the fourth communication device. The communication partner of the outdoor unit 120A is the indoor unit 220AA, and the communication partner of the indoor unit 220AA is the outdoor unit 120A.

The outdoor unit 120A has functional components including a verifier 101, a common key generator 102, a first encryptor 103, a common key transmitter 104, a second encryptor 105, a data transmitter 106, and a second decryptor 108. The indoor unit 220AA has functional components including a verifier 201, a second encryptor 205, a data transmitter 206, a first decryptor 207, and a second decryptor 208. The outdoor unit 120A has the same functions as the outdoor unit 100A except for that the outdoor unit 120A lacks the first decryptor 107. The indoor unit 220AA has the same functions as the indoor unit 200AA except for that the indoor unit 220AA lacks the common key generator 202, the first encryptor 203, and the common key transmitter 204.

The verifier 101 verifies the communication-partner device. The common key generator 102 generates a common key for use in encrypted communication. The common key generated by the common key generator 102 is stored into the storage 12. The first encryptor 103 encrypts the common key generated by the common key generator 102, with the public key of the communication-partner device. After the verification of the communication-partner device by the verifier 101, the common key transmitter 104 transmits the common key encrypted by the first encryptor 103, to the communication-partner device.

The second encryptor 105 encrypts data to be transmitted to the communication-partner device, with the common key generated by the common key generator 102. The data transmitter 106 transmits the data encrypted by the second encryptor 105 to the communication-partner device. The second decryptor 108 decrypts the encrypted data received from the communication-partner device, with the common key stored in the storage 12. The outdoor unit 120A may transfer data received from another communication device, to the indoor unit 220AA serving as the communication-partner device.

The verifier 201 verifies the communication-partner device. The second encryptor 205 encrypts data to be transmitted to the communication-partner device, with the common key decrypted by the first decryptor 207. The data transmitter 206 transmits the data encrypted by the second encryptor 205 to the communication-partner device. The first decryptor 207 decrypts the encrypted common key received from the communication-partner device, with the secret key of the indoor unit 220AA. The common key decrypted by the first decryptor 207 is stored into the storage 22. The second decryptor 208 decrypts the encrypted data received from the communication-partner device, with the common key stored in the storage 22. The data decrypted by the second decryptor 208 is stored into the storage 22.

In this embodiment, the outdoor unit 120A generates a common key applied to the encrypted communication in both communication directions, and the indoor unit 220AA does not generate any common key, as described above. In other words, one of the two devices that establish sessions therebetween generates a common key applied to the encrypted communication in both communication directions, in this embodiment. The number of common keys generated in this embodiment is equal to the half of the number of common keys generated in Embodiment 1. The embodiment thus has an advantage of a short processing period for generation of common keys and a low memory usage for storing the common keys. The embodiment can therefore further prevent an increase in the processing period for preparation of communication and an increase in the memory usage.

### Embodiment 3

Embodiment 1 demonstrates an example in which the communication partner is verified in the public key cryptosystem at the establishment of a TLS session. This embodiment demonstrates an example in which the communication partner is verified in the pre-shared key method at the establishment of a TLS session. The configurations and functions identical to those in Embodiments 1 and 2 are briefly described below without redundant description, as appropriate.

An air conditioning system according to this embodiment has basically the same configuration as the air conditioning system 1000 according to Embodiment 1. Specifically, the air conditioning system according to this embodiment includes two outdoor units, four indoor units, and a system controller, and one outdoor unit and two indoor units belong to each of two refrigerant groups. In this embodiment, one of the refrigerant groups includes an outdoor unit 130A and an indoor unit 230AA.

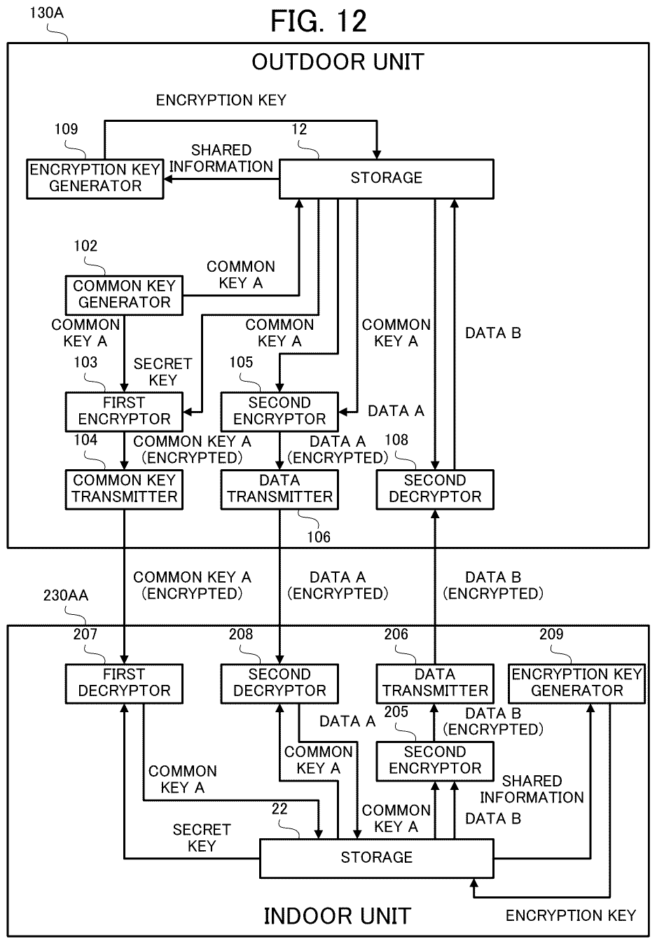

The following describes functions of the outdoor unit 130A and functions of the indoor unit 230AA with reference to FIG. 12, focusing on an example in which the outdoor unit 130A communicates with the indoor unit 230AA. In this embodiment, the outdoor unit 130A corresponds to the third communication device, and the indoor unit 230AA corresponds to the fourth communication device. The communication partner of the outdoor unit 130A is the indoor unit 230AA, and the communication partner of the indoor unit 230AA is the outdoor unit 130A.

The outdoor unit 130A has functional components including a common key generator 102, a first encryptor 103, a common key transmitter 104, a second encryptor 105, a data transmitter 106, a second decryptor 108, and an encryption key generator 109. The indoor unit 230AA has functional components including a second encryptor 205, a data transmitter 206, a first decryptor 207, a second decryptor 208, and an encryption key generator 209. The outdoor unit 130A has the same functions as the outdoor unit 100A except for that the outdoor unit 130A lacks the verifier 101 and the first decryptor 107 and includes the encryption key generator 109. The indoor unit 230AA has the same functions as the indoor unit 200AA except for that the indoor unit 230AA lacks the verifier 201, the common key generator 202, the first encryptor 203, and the common key transmitter 204 and includes the encryption key generator 209.

The common key generator 102 generates a common key for use in encrypted communication. The common key generated by the common key generator 102 is stored into the storage 12. The storage 12 in this embodiment does not store the server certificate of the outdoor unit 130A, the route certificate, the public key of the outdoor unit 130A, or the secret key of the outdoor unit 130A, because of no verification of the communication partner in the public key cryptosystem. Instead, the storage 12 in this embodiment stores encryption keys in the pre-shared key method, because of verification of the communication partner in the pre-shared key method. The storage 12 is an example of storage means.

The first encryptor 103 encrypts the common key generated by the common key generator 102, with the encryption key stored in the storage 12. The common key transmitter 104 transmits the common key encrypted by the first encryptor 103 to the communication-partner device. The second encryptor 105 encrypts data to be transmitted to the communication-partner device, with the common key generated by the common key generator 102.

The data transmitter 106 transmits the data encrypted by the second encryptor 105 to the communication-partner device. The second decryptor 108 decrypts the encrypted data received from the communication-partner device, with the common key stored in the storage 12. The outdoor unit 130A may transfer the data received from another communication device, to the indoor unit 230AA serving as the communication-partner device.

The encryption key generator 109 generates an encryption key in the pre-shared key method, from shared information provided during manufacture or before shipping of the outdoor unit 130A. This shared information is shared by the outdoor unit 130A and the indoor unit 230AA. The shared information is stored into the storage 12 during manufacture or before shipping of the outdoor unit 130A. The shared information is also stored into the storage 22 during manufacture of the indoor unit 230AA. A typical example of the shared information is manufacturer identification information indicating the manufacturer that produced the outdoor unit 130A and the indoor unit 230AA.

In general, outdoor units and indoor units included in a certain air conditioning system are produced by the same manufacturer. The shared information stored in the storage 12 is thus identical to the shared information stored in the storage 22, assuming that the shared information is the manufacturer identification information. The encryption key generator 109 generates an encryption key from the shared information, in accordance with a key generation algorithm for generating an encryption key in the pre-shared key method. This key generation algorithm causes generation of the identical encryption key from the same shared information and causes generation of different encryption keys from different shared information.

The encryption key generator 209, which is described below, also generates an encryption key from the shared information, in accordance with this key generation algorithm. When the shared information stored in the storage 12 is identical to the shared information stored in the storage 22, the encryption key generated by the encryption key generator 109 is identical to the encryption key generated by the encryption key generator 209. In contrast, when the shared information stored in the storage 12 differs from the shared information stored in the storage 22, the encryption key generated by the encryption key generator 109 differs from the encryption key generated by the encryption key generator 209. The encryption key generated by the encryption key generator 109 is stored into the storage 12. The encryption key generator 109 is an example of encryption key generating means.

The second encryptor 205 encrypts data to be transmitted to the communication-partner device, with the common key decrypted by the first decryptor 207 and stored in the storage 22. The data transmitter 206 transmits the data encrypted by the second encryptor 205 to the communication-partner device.

The storage 22 in this embodiment does not store the server certificate of the indoor unit 230AA, the route certificate, the public key of the indoor unit 230AA, or the secret key of the indoor unit 230AA, because of no verification of the communication partner in the public key cryptosystem. Instead, the storage 22 in this embodiment stores encryption keys in the pre-shared key method, because of verification of the communication partner in the pre-shared key method. The storage 22 is an example of the storage means.

The first decryptor 207 decrypts the encrypted common key received from the communication-partner device, with the encryption key in the pre-shared key method, which is stored in the storage 22. The common key decrypted by the first decryptor 207 is stored into the storage 22. The second decryptor 208 decrypts the encrypted data received from the communication-partner device, with the common key stored in the storage 22. The data decrypted by the second decryptor 208 is stored into the storage 22.

The encryption key generator 209 generates an encryption key in the pre-shared key method, from the shared information provided during manufacture of the indoor unit 230AA. The shared information is stored into the storage 22 during manufacture or before shipping of the indoor unit 230AA. The encryption key generator 209 generates an encryption key from the shared information, in accordance with the above-mentioned key generation algorithm. The encryption key generated by the encryption key generator 209 is stored into the storage 22. The encryption key generator 209 is an example of the encryption key generating means.

The other outdoor units, the other indoor units, and the system controller according to this embodiment have the function of generating an encryption key from the shared information in accordance with the above-mentioned key generation algorithm, like the outdoor unit 130A and the indoor unit 230AA. In other words, the individual devices according to this embodiment generate the identical encryption key from the identical shared information, and thus share the encryption key in the pre-shared key method.

In this embodiment, the communication partner is verified in the pre-shared key method at the establishment of a TLS session. In other words, the devices are mutually verified through sharing of the encryption key in the pre-shared key method in this embodiment. This embodiment does not require verification of the communication partner in the public key cryptosystem, and can therefore further prevent an increase in the processing period for preparation of communication.

In this embodiment, the two devices that establish sessions therebetween generate an encryption key in the pre-shared key method, from the shared information provided during manufacture or before shipping. The shared information provided during manufacture or before shipping is the manufacturer identification information in this embodiment. The devices produced by the same manufacturer share the identical encryption key. The embodiment can therefore readily achieve sharing of the encryption key at the building of an air conditioning system including devices produced by the same manufacturer.

### Embodiment 4

Embodiment 3 demonstrates an example in which the encryption key in the pre-shared key method is generated from the shared information provided during manufacture or before shipping. This embodiment demonstrates an example in which the encryption key in the pre-shared key method is generated from shared information provided at the building of the system. The configurations and functions identical to those in Embodiments 1 to 3 are briefly described below without redundant description, as appropriate.

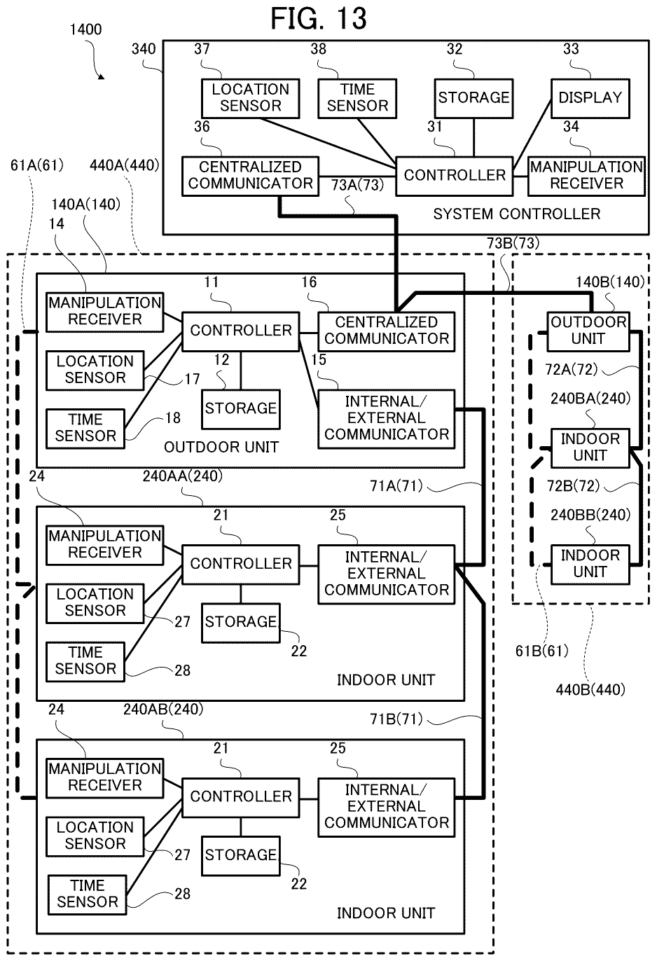

FIG. 13 illustrates a configuration of an air conditioning system 1400 according to Embodiment 4. The air conditioning system 1400 includes an outdoor unit 140A, an outdoor unit 140B, an indoor unit 240AA, an indoor unit 240AB, an indoor unit 240BA, an indoor unit 240BB, and a system controller 340. The outdoor unit 140A and the outdoor unit 140B are hereinafter collectively referred to as “outdoor units 140”, and the indoor unit 240AA, the indoor unit 240AB, the indoor unit 240BA, and the indoor unit 240BB are hereinafter collectively referred to as “indoor units 240”, as appropriate.

The air conditioning system 1400 includes, as refrigerant groups, a refrigerant group 440A and a refrigerant group 440B. The refrigerant group 440A and the refrigerant group 440B are hereinafter collectively referred to as “refrigerant groups 440”, as appropriate. The refrigerant group 440A includes the outdoor unit 140A, the indoor unit 240AA, the indoor unit 240AB, and a refrigerant pipe 61A. The refrigerant group 440B includes the outdoor unit 140B, the indoor unit 240BA, the indoor unit 240BB, and a refrigerant pipe 61B.

Each of the outdoor units 140 includes a controller 11, a storage 12, a manipulation receiver 14, an internal/external communicator 15, a centralized communicator 16, a location sensor 17, and a time sensor 18. Each of the indoor units 240 includes a controller 21, a storage 22, a manipulation receiver 24, an internal/external communicator 25, a location sensor 27, and a time sensor 28. The system controller 340 includes a controller 31, a storage 32, a display 33, a manipulation receiver 34, a centralized communicator 36, a location sensor 37, and a time sensor 38.

The outdoor unit 140 has the same configuration as the outdoor unit 100 except for that the outdoor unit 140 includes the manipulation receiver 14, the location sensor 17, and the time sensor 18. The indoor unit 240 has the same configuration as the indoor unit 200 except for that the indoor unit 240 includes the manipulation receiver 24, the location sensor 27, and the time sensor 28. The system controller 340 has the same configuration as the system controller 300 except for that the system controller 340 includes the location sensor 37 and the time sensor 38.

The manipulation receiver 14 receives various manipulations from the user, and feeds information indicating the received manipulations to the controller 11. For example, the manipulation receiver 14 receives, from the user, setting information for generation of an encryption key in the pre-shared key method, at the building of the air conditioning system 1400. The manipulation receiver 14 includes a touch screen, buttons, or levers, for example. The location sensor 17 detects the location of installation of the outdoor unit 140. The location sensor 17 includes a global positioning system (GPS) receiver, for example. The time sensor 18 detects the current time. The time sensor 18 includes a radio watch or a GPS receiver, for example.

The manipulation receiver 24 receives various manipulations from the user, and feeds information indicating the received manipulations to the controller 21. For example, the manipulation receiver 24 receives the setting information from the user, at the building of the air conditioning system 1400. The manipulation receiver 24 includes a touch screen, buttons, or levers, for example. The location sensor 27 detects the location of installation of the indoor unit 240. The location sensor 27 includes a GPS receiver, for example. The time sensor 28 detects the current time. The time sensor 28 includes a radio watch or a GPS receiver, for example.

The manipulation receiver 34 receives the setting information from the user, at the building of the air conditioning system 1400. The location sensor 37 detects the location of installation of the system controller 340. The location sensor 37 includes a GPS receiver, for example. The time sensor 38 detects the current time. The time sensor 38 includes a radio watch or a GPS receiver, for example.

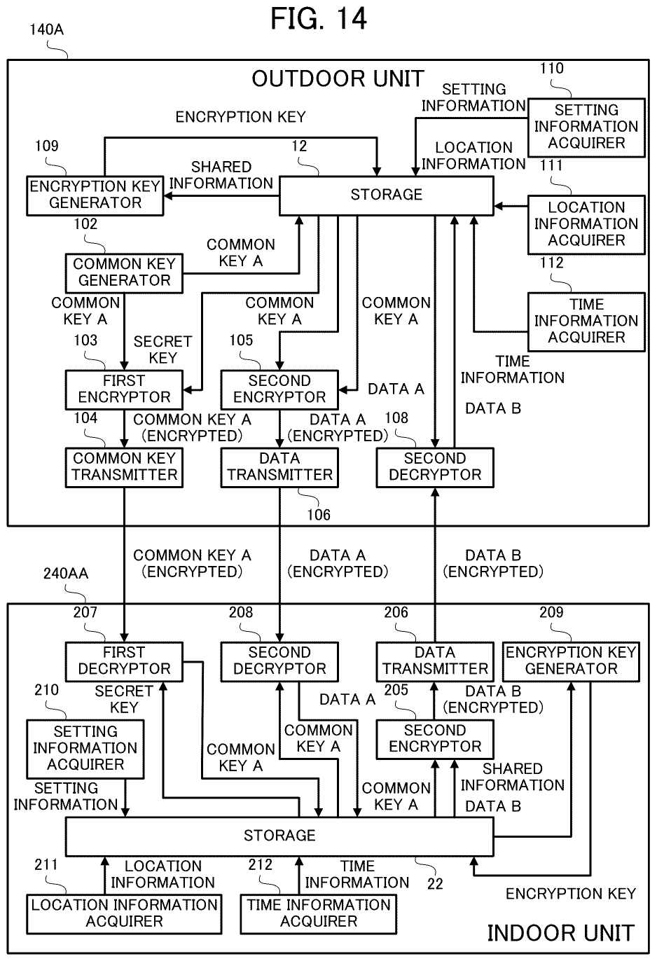

The following describes functions of the outdoor unit 140A and functions of the indoor unit 240AA with reference to FIG. 14, focusing on an example of communication between the outdoor unit 140A and the indoor unit 240AA. In this embodiment, the outdoor unit 140A corresponds to the third communication device, and the indoor unit 240AA corresponds to the fourth communication device. The communication partner of the outdoor unit 140A is the indoor unit 240AA, and the communication partner of the indoor unit 240AA is the outdoor unit 140A.

The outdoor unit 140A has functional components including a common key generator 102, a first encryptor 103, a common key transmitter 104, a second encryptor 105, a data transmitter 106, a second decryptor 108, an encryption key generator 109, a setting information acquirer 110, a location information acquirer 111, and a time information acquirer 112. The indoor unit 240AA has functional components including a second encryptor 205, a data transmitter 206, a first decryptor 207, a second decryptor 208, an encryption key generator 209, a setting information acquirer 210, a location information acquirer 211, and a time information acquirer 212. The outdoor unit 140A has the same functions as the outdoor unit 130A except for that the outdoor unit 140A includes the setting information acquirer 110, the location information acquirer 111, and the time information acquirer 112. The indoor unit 240AA has the same functions as the indoor unit 230AA except for that the indoor unit 240AA includes the setting information acquirer 210, the location information acquirer 211, and the time information acquirer 212.

The setting information acquirer 110 acquires setting information from the user, via the manipulation receiver 14. The setting information acquirer 210 acquires this setting information from the user, via the manipulation receiver 24. The setting information is provided by the user for generation of an encryption key in the pre-shared key method, at the building of the air conditioning system 1400. The user sets the identical setting information to the individual devices included in the air conditioning system 1400, at the building of the air conditioning system 1400. The setting information acquired by the setting information acquirer 110 is thus basically identical to the setting information acquired by the setting information acquirer 210. The setting information acquirers 110 and 210 are examples of setting information acquiring means.

The location information acquirer 111 acquires information indicating the location of installation of the outdoor unit 140A from the location sensor 17, as the location information indicating the location of building of the air conditioning system 1400. The location information acquirer 211 acquires information indicating the location of installation of the indoor unit 240AA from the location sensor 27, as the location information indicating the location of building of the air conditioning system 1400.

The location information roughly indicates the location of building of the air conditioning system 1400, in terms of the name of municipality and the block number, for example. In general, the location of installation of the outdoor unit 140A has no significant difference from the location of installation of the indoor unit 240AA. The location information acquired by the location information acquirer 111 is thus basically identical to the location information acquired by the location information acquirer 211. The location information acquirers 111 and 211 are examples of location information acquiring means.

The time information acquirer 112 acquires information indicating the time of activation of the outdoor unit 140A from the time sensor 18, as the time information indicating the time of building of the air conditioning system 1400. The time information acquirer 212 acquires information indicating the time of activation of the indoor unit 240AA from the time sensor 28, as the time information indicating the time of building of the air conditioning system 1400.

The time information roughly indicates the time of building of the air conditioning system 1400, in terms of month, week, and day, for example. In general, the time of activation of the outdoor unit 140A has no significant difference from the time of activation of the indoor unit 240AA. The time information acquired by the time information acquirer 112 is thus basically identical to the time information acquired by the time information acquirer 212. The time information acquirers 112 and 212 are examples of time information acquiring means.

The encryption key generators 109 and 209 each generate an encryption key in the pre-shared key method, from the shared information acquired at the building of the air conditioning system 1400. Specifically, the encryption key generator 109 generates an encryption key, from the shared information containing at least one of the setting information acquired by the setting information acquirer 110, the location information acquired by the location information acquirer 111, and the time information acquired by the time information acquirer 112. The encryption key generator 209 generates an encryption key, from the shared information containing at least one of the setting information acquired by the setting information acquirer 210, the location information acquired by the location information acquirer 211, and the time information acquired by the time information acquirer 212.

The setting information, location information, and time information acquired by the outdoor unit 140A are basically identical to the setting information, location information, and time information acquired by the indoor unit 240AA, respectively. In other words, the shared information acquired by the outdoor unit 140A is identical to the shared information acquired by the indoor unit 240AA. The encryption key generators 109 and 209 each generate an encryption key from the shared information, in accordance with the same key generation algorithm. The encryption key generated by the encryption key generator 109 is accordingly identical to the encryption key generated by the encryption key generator 209. The identical encryption key is thus shared by the outdoor unit 140A and the indoor unit 240AA.

In the case of generation of an encryption key from the shared information containing the setting information, the encryption key is shared by the devices provided with the same setting information. In the case of generation of an encryption key from the shared information containing the location information, the encryption key is shared by the devices installed at the same location. In the case of generation of an encryption key from the shared information containing the time information, the encryption key is shared by the devices activated at the same time. In the case of generation of an encryption key from the shared information containing the setting information and the location information, the encryption key is shared by the devices provided with the same setting information and installed at the same location.

In the case of generation of an encryption key from the shared information containing the setting information and the time information, the encryption key is shared by the devices provided with the same setting information and activated at the same time. In the case of generation of an encryption key from the shared information containing the location information and the time information, the encryption key is shared by the devices installed at the same location and activated at the same time. In the case of generation of an encryption key from the shared information containing the setting information, the location information, and the time information, the encryption key is shared by the devices provided with the same setting information, installed at the same location, and activated at the same time.

The storage 12 stores the encryption key generated by the encryption key generator 109. The storage 22 stores the encryption key generated by the encryption key generator 209.

The first encryptor 103 encrypts the common key generated by the common key generator 102, with the encryption key stored in the storage 12. The common key transmitter 104 transmits the common key encrypted by the first encryptor 103 to the communication-partner device. The first decryptor 207 decrypts the encrypted common key received from the communication-partner device, with the encryption key in the pre-shared key method, which is stored in the storage 22. The common key decrypted by the first decryptor 207 is stored into the storage 22.

The other outdoor units, the other indoor units, and the system controller according to this embodiment have the function of generating an encryption key from the shared information in accordance with the above-mentioned key generation algorithm, like the outdoor unit 140A and the indoor unit 240AA. In other words, the individual devices according to this embodiment generate the identical encryption key from the identical shared information, and thus share the encryption key in the pre-shared key method.

In this embodiment, the communication partner is verified in the pre-shared key method at the establishment of a TLS session. This embodiment does not require verification of the communication partner in the public key cryptosystem, and can therefore further prevent an increase in the processing period for preparation of communication.

In this embodiment, the two devices that establish sessions therebetween generate an encryption key in the pre-shared key method, from the shared information provided at the building of the system. The shared information provided at the building of the system contains at least one of the setting information, location information, and time information in this embodiment. The identical encryption key is thus shared by the devices having the same setting information, the same time of activation, the same location of installation, or combinations thereof. This embodiment can thus achieve sharing of the encryption key even in the case of building of an air conditioning system including devices produced by different manufacturers. The identical encryption key is not shared by devices different in at least any of the setting information, the time of activation, and the location of installation, in this embodiment. The embodiment can therefore reduce the risks caused by leakage of the encryption key.

### Embodiment 5

Embodiment 1 demonstrates an example in which completion of sharing of a common key for use in encrypted communication is immediately followed by the air conditioning control. This embodiment demonstrates an example in which the air conditioning control is executed after completion of sharing of a common key for use in encrypted communication and then confirmation of the devices connected to the air conditioning system by the user. The configurations and functions identical to those in Embodiments 1 to 4 are briefly described below without redundant description, as appropriate.

An air conditioning system according to this embodiment has basically the same configuration as the air conditioning system 1000 according to Embodiment 1. In this embodiment, the system controller 300 acquires device information from the individual devices, after establishing sessions between the devices. The device information indicates names, serial numbers, type names, and classifications of the devices, and refrigerant groups to which the devices belong. After establishing sessions between all the combinations of the devices that execute encrypted communication, the system controller 300 displays a screen for presenting all the acquired device information to the user.

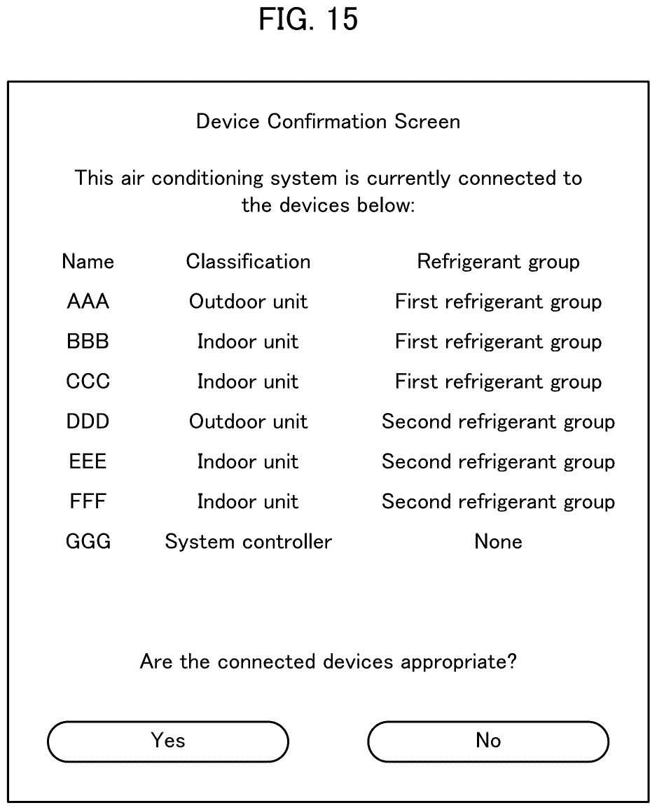

For example, the display 33 of the system controller 300 displays the device confirmation screen illustrated in FIG. 15. This device confirmation screen presents the device information containing names, classifications, and refrigerant groups of the devices, on all the devices connected to the air conditioning system 1000. The device confirmation screen is designed to ask the user whether the devices connected to the air conditioning system 1000 are appropriate.

The display 33 displays the device information on all the devices that execute encrypted communication, after completion of sharing of the common keys for all the encrypted communication between the first air conditioning devices and the second air conditioning devices. The display 33 is an example of display means.

The user confirms the device information on the device confirmation screen, and determines whether the devices connected to the air conditioning system 1000 are appropriate. When determining that the devices connected to the air conditioning system 1000 are appropriate, the user provides an instruction to initiate the air conditioning control to the manipulation receiver 34 of the system controller 300. The manipulation receiver 34 receives the instruction to initiate the air conditioning control from the user, after display of the device information on the display 33. In contrast, when the user determines that the devices connected to the air conditioning system 1000 are inappropriate, the user notifies the manipulation receiver 34 of an abnormality. The manipulation receiver 34 is an example of initiation instruction receiving means.

The system controller 300, after receiving the instruction to initiate the air conditioning control from the user, initiates the air conditioning control. The system controller 300 may automatically execute the air conditioning control in accordance with predetermined setting, or execute the air conditioning control in accordance with a manipulation of the user.

In this embodiment, the air conditioning control is executed after verification of the devices by the user in addition to verification of the devices by the devices. That is, the embodiment has an advantage of two-phase verification involving verification of the devices by the devices and verification of the devices by the user. The embodiment can therefore reduce the risks of allowing an inappropriate device to be connected to the air conditioning system 1000.

### Embodiment 6

Embodiment 1 demonstrates an example in which the devices execute internal/external communication or centralized communication with each other. This embodiment demonstrates an example in which the devices execute integrated communication with each other, which involves internal/external communication and centralized communication. The configurations and functions identical to those in Embodiments 1 to 5 are briefly described below without redundant description, as appropriate.

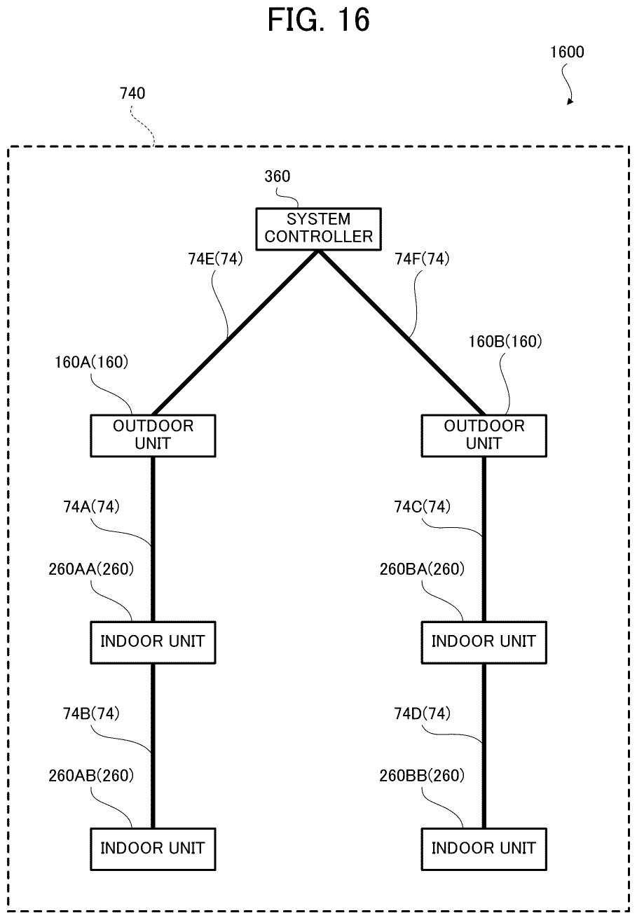

FIG. 16 illustrates a network configuration of an air conditioning system 1600 according to this embodiment. In this embodiment, an outdoor unit 160A, an outdoor unit 160B, an indoor unit 260AA, an indoor unit 260AB, an indoor unit 260BA, an indoor unit 260BB, a system controller 360, a communication line 74A, a communication line 74B, a communication line 74C, a communication line 74D, a communication line 74E, and a communication line 74F constitute a communication network 740.

The outdoor unit 160A and the outdoor unit 160B are hereinafter collectively referred to as “outdoor units 160”, and the indoor unit 260AA, the indoor unit 260AB, the indoor unit 260BA, and the indoor unit 260BB are hereinafter collectively referred to as “indoor units 260”, as appropriate. The communication line 74A, the communication line 74B, the communication line 74C, the communication line 74D, the communication line 74E, and the communication line 74F are hereinafter collectively referred to as “communication lines 74”, as appropriate. Each of the communication lines 74 is an Ethernet (registered trademark) cable, for example.

The outdoor unit 160A, the indoor unit 260AA, and the indoor unit 260AB belong to a refrigerant group different from the refrigerant group to which the outdoor unit 160B, the indoor unit 260BA, and the indoor unit 260BB belong. All the devices in this embodiment, however, configure the single communication network 740, regardless of the refrigerant groups 400. The communication network 740 is configured by interconnecting all the devices. The communication network 740 is a LAN capable of IP communication.

The communication line 74A connects the outdoor unit 160A to the indoor unit 260AA. The communication line 74B connects the indoor unit 260AA to the indoor unit 260AB. The communication line 74C connects the outdoor unit 160B to the indoor unit 260BA. The communication line 74D connects the indoor unit 260BA to the indoor unit 260BB. The communication line 74E connects the outdoor unit 160A to the system controller 360. The communication line 74F connects the outdoor unit 160B to the system controller 360.

In this embodiment, the encrypted communication is executed within each refrigerant group, and the encrypted communication across different refrigerant groups is relayed by the relay devices belonging to the respective refrigerant groups, as in Embodiment 1. That is, the first air conditioning devices belonging to the first refrigerant group execute encrypted communication with each other. The outdoor unit 160A, the indoor unit 260AA, and the indoor unit 260AB are examples of the first air conditioning devices. The refrigerant group to which the outdoor unit 160A, the indoor unit 260AA, and the indoor unit 260AB belong is an example of the first refrigerant group. The second air conditioning devices belonging to the second refrigerant group execute encrypted communication with each other. The outdoor unit 160B, the indoor unit 260BA, and the indoor unit 260BB are examples of the second air conditioning devices. The refrigerant group to which the outdoor unit 160B, the indoor unit 260BA, and the indoor unit 260BB belong is an example of the second refrigerant group.

When the first communication device communicates with the second communication device, the first relay device and the second relay device execute encrypted communication with each other. The first communication device is any of the first air conditioning devices. The second communication device is any of the second air conditioning devices. The first relay device is any of the first air conditioning devices. The second relay device is any of the second air conditioning devices. The outdoor unit 160A is an example of the first relay device. The outdoor unit 160B is an example of the second relay device.

The first relay device, when the first relay device is not the first communication device, relays communication between the first communication device and the second communication device. The second relay device, when the second relay device is not the second communication device, relays communication between the first communication device and the second communication device. The first relay device, when the first relay device is not the first communication device, relays communication between the first communication device and the system controller 360. The second relay device, when the second relay device is not the second communication device, relays communication between the second communication device and the system controller 360.

In this embodiment, when the first communication device belonging to the first refrigerant group communicates with the second communication device belonging to the second refrigerant group, the first relay device belonging to the first refrigerant group and the second relay device belonging to the second refrigerant group execute encrypted communication with each other. The embodiment can therefore achieve secure communication while maintaining a short processing period for preparation of communication and low memory usage.

### Modifications

The above-described embodiments of the present disclosure may be varied and revised into various modifications. The modifications may employ any part of the configurations, functions, and operations described in the embodiments. The modifications may also employ configurations, functions, and operations other than the above-described configurations, functions, and operations. The configurations, functions, and operations described in the embodiments may be combined with each other in any manner.

Embodiment 1 demonstrates an example in which the air conditioning system 1000 includes two refrigerant groups 400. Alternatively, the air conditioning system 1000 may include three or more refrigerant groups 400. Embodiment 1 demonstrates an example in which each refrigerant group 400 includes one outdoor unit 100 and two indoor units 200. Alternatively, the refrigerant group 400 may include two or more outdoor units 100, and one indoor unit 200 or three or more indoor units 200. Embodiment 1 demonstrates an example in which the air conditioning system 1000 includes the system controller 300. Alternatively, the air conditioning system 1000 may exclude the system controller 300.

Embodiment 1 demonstrates an example in which the devices included in each communication network are connected by wire to each other. Alternatively, the devices included in each communication network may be connected by wireless to each other. Embodiment 1 demonstrates an example in which the outdoor units 100 included in the refrigerant groups 400 serve as relay devices that relay encrypted communication. Alternatively, the indoor units 200 included in the refrigerant groups 400 may serve as relay devices that relay encrypted communication.

Embodiment 3 demonstrates an example in which an encryption key is generated from the shared information provided during manufacture or before shipping of the device. Alternatively, the encryption key may be provided by the user during manufacture or before shipping of the device. This configuration does not require the device to generate an encryption key. The user can provide the device with an encryption key depending on the manufacturer that produced the device, by manipulating the manipulation receiver 14, 24, or 34, for example.

Embodiment 4 demonstrates an example in which an encryption key is generated from the shared information provided at the building of the system. Alternatively, the encryption key may be provided by the user at the building of the system. This configuration does not require the device to generate an encryption key. The user can provide the devices with an encryption key shared by the devices, by manipulating the manipulation receiver 14, 24, or 34, for example.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Industrial Applicability

The present disclosure can be applied to an air conditioning system including an outdoor unit and an indoor unit.

1. An air conditioning system comprising:
first air conditioning devices belonging to a first refrigerant group; and
second air conditioning devices belonging to a second refrigerant group, the first air conditioning devices and the second air conditioning devices being connected so as to be capable of communication with each other, wherein
the first air conditioning devices execute encrypted communication with each other, the encrypted communication involving encryption of communication data with a common key,
the second air conditioning devices execute the encrypted communication with each other, and
when a first communication device among the first air conditioning devices communicates with a second communication device among the second air conditioning devices, a first relay device among the first air conditioning devices and a second relay device among the second air conditioning devices execute the encrypted communication with each other.

2. The air conditioning system according to claim 1, wherein
when the first relay device is not the first communication device, the first relay device relays communication between the first communication device and the second communication device,
by executing the encrypted communication using a first common key shared by the first relay device and the second relay device, with the second relay device, and
by executing the encrypted communication using a second common key shared by the first relay device and the first communication device, with the first communication device, and
when the second relay device is not the second communication device, the second relay device relays communication between the first communication device and the second communication device,
by executing the encrypted communication using the first common key, with the first relay device, and
by executing the encrypted communication using a third common key shared by the second relay device and the second communication device, with the second communication device.

3. The air conditioning system according to claim 1, further comprising:
a system controller to control the first air conditioning devices and the second air conditioning devices, wherein
the first relay device and the system controller execute the encrypted communication with each other, when the first communication device communicates with the system controller, and
the second relay device and the system controller execute the encrypted communication with each other, when the second communication device communicates with the system controller.

4. The air conditioning system according to claim 3, wherein
when the first relay device is not the first communication device, the first relay device relays communication between the first communication device and the system controller,
by executing the encrypted communication using a second common key shared by the first relay device and the first communication device, with the first communication device, and
by executing the encrypted communication using a fourth common key shared by the first relay device and the system controller, with the system controller, and
when the second relay device is not the second communication device, the second relay device relays communication between the second communication device and the system controller,
by executing the encrypted communication using a third common key shared by the second relay device and the second communication device, with the second communication device, and
by executing the encrypted communication using a fifth common key shared by the second relay device and the system controller, with the system controller.

5. The air conditioning system according to claim 1, wherein
the first air conditioning devices belong to a first communication network,
the second air conditioning devices belong to a second communication network different from the first communication network, and
the first relay device and the second relay device belong to a third communication network different from the first communication network and the second communication network.

6. The air conditioning system according to claim 1, wherein
the first air conditioning devices and the second air conditioning devices include a third communication device, and
the third communication device includes processing circuitry, the processing circuitry being configured to
verify a fourth communication device among the first air conditioning devices and the second air conditioning devices, the fourth communication device being configured to communicate with the third communication device,
generate the common key for use in the encrypted communication, and
transmit the generated common key to the fourth communication device, after verification of the fourth communication device.

7. The air conditioning system according to claim 1, wherein
the first air conditioning devices and the second air conditioning devices include a third communication device and a fourth communication device configured to communicate with the third communication device,
each of the third communication device and the fourth communication device includes
processing circuitry, and
a memory to store an encryption key in a pre-shared key method, and
the processing circuitry included in the third communication device is configured to
generate the common key for use in the encrypted communication,
encrypt the generated common key with the encryption key stored in the memory included in the third communication device, and
transmit the encrypted common key to the fourth communication device.

8. The air conditioning system according to claim 7, wherein
the processing circuitry included in the third communication device is further configured to
generate the encryption key from shared information provided during manufacture or before shipping of the third communication device, the encryption key being to be stored in the memory included in the third communication device, and
the processing circuitry included in the fourth communication device is further configured to
generate the encryption key from the shared information provided during manufacture or before shipping of the fourth communication device, the encryption key being to be stored in the memory included in the fourth communication device.

9. The air conditioning system according to claim 7, wherein
the processing circuitry included in the third communication device is further configured to
generate the encryption key from shared information acquired at building of the air conditioning system, the encryption key being to be stored in the memory included in the third communication device, and
the processing circuitry included in the fourth communication device is further configured to
generate the encryption key from the shared information acquired at building of the air conditioning system, the encryption key being to be stored in memory included in the fourth communication device.

10. The air conditioning system according to claim 9, wherein
the processing circuitry included in each of the third communication device and the fourth communication device is further configured to
acquire setting information provided by a user at building of the air conditioning system, and
the shared information contains the acquired setting information.

11. The air conditioning system according to claim 9, wherein
the shared information contains location information indicating a location of building of the air conditioning system,
the processing circuitry included in the third communication device further includes
acquire, as the location information, information indicating a location of installation of the third communication device, and
the processing circuitry included in the fourth communication device further includes
acquire, as the location information, information indicating a location of installation of the fourth communication device.

12. The air conditioning system according to claim 9, wherein
the shared information contains time information indicating a time of building of the air conditioning system,
the processing circuitry included in the third communication device further includes
acquire, as the time information, information indicating a time of activation of the third communication device, and
the processing circuitry included in the fourth communication device further includes
acquire, as the time information, information indicating a time of activation of the fourth communication device.

13. The air conditioning system according to claim 1, further comprising:
a display to display device information on each of the first air conditioning devices and the second air conditioning devices, after completion of sharing of the common keys in the encrypted communication between the first air conditioning devices, the encrypted communication between the second air conditioning devices, and the encrypted communication between the first relay device and the second relay device; and
an initiation instruction receiver to receive an instruction to initiate air conditioning control from a user, after the display displays the device information.

14. A communication method executed by an air conditioning system including first air conditioning devices belonging to a first refrigerant group and second air conditioning devices belonging to a second refrigerant group, the first air conditioning devices and the second air conditioning devices being connected so as to be capable of communication with each other, the communication method comprising:
executing encrypted communication between the first air conditioning devices, the encrypted communication involving encryption of communication data with a common key;
executing the encrypted communication between the second air conditioning devices; and
executing the encrypted communication between a first relay device among the first air conditioning devices and a second relay device among the second air conditioning devices, when a first communication device among the first air conditioning devices communicates with a second communication device among the second air conditioning devices.
